(19) United States
(12) Patent Application Publication
(10) Pub. No.: US 2016/0242218 A1
(43) Pub. Date: Aug. 18, 2016

(54) COMMUNICATIONS METHOD, USER EQUIPMENT, AND WIRELESS COMMUNICATIONS SYSTEM FOR SUPPORTING DEVICE TO DEVICE COMMUNICATIONS

(71) Applicant: NEC CORPORATION, Minato-ku, Tokyo (JP)

(72) Inventor: Phong NGUYEN, Victoria (AU)

(73) Assignee: NEC Corporation, Tokyo (JP)

(21) Appl. No.: 14/773,925

(22) PCT Filed: Oct. 30, 2014
(86) PCT No.: PCT/JP2014/079653

§ 371 Date: Sep. 9, 2015

(30) Foreign Application Priority Data
Oct. 31, 2013 (AU) 2013904205

(51) Int. Cl. H04W 76/02; H04W 72/04

(52) U.S. Cl. CPC H04W 76/023; H04W 72/0446; H04W 92/18

(57) ABSTRACT

A method is disclosed for sending and receiving D2D subframes. The method may be applied in a system where a transmitting D2D-UE and one or more paired receiving D2D-UE(s) all belong to a single serving base station. The serving base station, which provides cell coverage for both the transmitting D2D-UE and the receiving D2D-UE(s), may be operated using FDD or TDD. The method may also be applied in a system where the transmitting D2D-UE and the receiving D2D-UE(s), respectively, belong to different servicing base stations. In this case, one base station provides cell coverage for the transmitting D2D-UE and another base station provides cell coverage for the receiving D2D-UE(s).

### TECHNICAL FIELD

Embodiments of the present invention relate generally to wireless communications systems, methods and apparatus, and more particularly to methods, apparatus and techniques for so called “device to device” (or “peer to peer”) communication in systems which support both device to device communication (a.k.a direct communication or D2D communication) and also network controlled communication such as cellular network communication.

### BACKGROUND ART

The following abbreviations are used herein:

| | |
|---|---|
| 3GPP | third generation partnership project |
| CP | cyclic prefix |
| D2D | device to device |
| D2D-UE | cellular user equipment (UE) with direct communication |
| | capability |
| DL | downlink |
| DTX | discontinuous transmission |
| FDD | frequency division duplex |
| GP | guard period |
| OFDM | orthogonal frequency division multiplexing |
| RX | receive |
| SC-FDMA | single carrier frequency division multiple access |
| SF | subframe |
| TA | timing advance |
| TDD | time division duplex |
| TX | transmit |
| UE | user equipment |
| UL | uplink |
| UpPTS | uplink pilot time slot |

Wireless communications networks and systems have been widely deployed and utilised for the past decade or more, and will likely continue to evolve in the future to provide communication content such as voice, video, packet data, messages, multimedia, broadcast, multicast, etc. These networks may be multiple-access networks including, for example, Time Division Multiple Access (TDMA) networks, Code Division Multiple Access (CDMA) networks, Frequency Division Multiple Access (FDMA) networks, Orthogonal FDMA (OFDMA) networks and/or Single Carrier FDMA (SC-FDMA) networks. A wireless communications network may also be referred to as a wide area network (WAN).

A wireless communications network may include a number of base stations that can provide wireless connectivity supporting communication by a number of mobile devices (mobile devices are also referred to as ‘user equipments’ or UEs). A mobile device (UE) may communicate with a base station via uplink and downlink channels. Downlink (also called the forward link) refers to the communication link from a base station to a mobile device (UE), and uplink (also called the reverse link) refers to the communication link from a mobile device (UE) to a base station.

Recently in the field of wireless communications, there has been a trend to make available and utilise licensed spectrum which is allocated for cellular networks for direct communication between one mobile device (UE) and another mobile device (UE), or among a group of mobile devices (UEs) within a local vicinity. This is referred to as direct or device to device (D2D) communication. Direct (D2D) communication may have advantages over cellular network communication, or it may coexist with the overlaid cellular network, thus improving overall spectral efficiency. For example, direct communication may be well suited for communicating small amounts of payload information directly and with low overhead compared with cellular network communication. Additionally, direct communication may be well suited to efficient communications in small local regions where channel conditions between the various devices may be good or better than the channel condition between the devices and base station(s). Furthermore, direct communication may allow an overlaid cellular network to offload traffic going through its base stations by allowing multiple paired devices to perform direct communication sharing the same allocated block of cellular network resources.

Very recently, 3GPP has recognised the potential importance of device to device communication operating on cellular licensed spectrum, and has endorsed a study item (SI) on device to device (D2D) communication. 3GPP SA (3GPP's Services and Systems Aspects technical specification group) and 3GPP RAN (3GPP's Radio Access Network technical specification group) have agreed that D2D communication may happen between D2D capable UEs (i.e. between so called D2D-UEs) which form a pair (or group) for D2D communication. Paired (or grouped) D2D-UEs may belong to the same or different cells/base stations. 3GPP RAN, and in particular 3GPP RAN-WG1 (one of the 3GPP RAN working groups), has agreed that D2D may operate in UL spectrum (in the case of FDD) or in UL subframes (in case of TDD) of the cell. 3GPP RAN-WG1 has also agreed that D2D transmission/reception should not use full duplex on a given carrier. Accordingly, D2D communication and cellular UL transmission are to share UL resource(s).

### SUMMARY OF INVENTION

### Technical Problem

Sharing the same resources for different kinds of communications (i.e. for cellular communication and D2D communication) may result in various types of interferences including, for example, timing misalignment of transmitted and received subframes, timing misalignment due to different synchronisation sources such as paired D2D-UEs belonging to different base stations, imperfect synchronisation among base stations, RX-to-TX or TX-to-TX transition switching, etc. Timing misalignments may result in intra-UE collision and/or inter-UE interference.

It is thought that resolving or managing intra-UE collision and/or inter-UE interference may be achieved through careful D2D subframe design. Therefore, in this document, carefully selected scenarios are chosen for timing analysis to illustrate the bad or “worst cases” of intra-UE collision and/or inter-UE interference, and based on this subframe designs for D2D communication are proposed for use in D2D communication between or among D2D-UEs belonging to the same or different servicing base stations.

### Solution to Problem

It is to be clearly understood that mere reference herein to previous or existing apparatus, systems, methods, practices, standards (or information in any way relating to standards), publications or other information, or to any problems or issues, does not constitute an acknowledgement or admission that any of those things individually or in any combination formed part of the common general knowledge of those skilled in the field, or that they are admissible prior art.

The present invention, at least in one form, is directed broadly to a signalling method for use in an advanced wireless communications system, wherein the system includes:

at least one servicing base station; and
at least a first and a second direct (D2D) communication capable user equipment (D2D-UE), wherein each D2D-UE is in cellular communication with a servicing base station, and the first D2D-UE and second D2D-UE, at least, are paired or grouped for D2D communication with one another,
the method comprising, on a given subframe,
performing D2D communication by transmitting D2D channel(s) and/or D2D signal(s) between one D2D-UE and another using a D2D subframe type which allows RX-TX switching time and/or prevents subframe collision at the receiving D2D-UE.

This method may therefore assist in managing and/or resolving intra-UE collision and/or inter-UE interference due to, for example, timing misalignment, and it may hence help to enable direct communication in order to achieve higher end-user data rates in comparison to traditional cellular communication (alone). The method may also help to allow D2D communication sharing the same UL resource, or UL subframes dynamically, on a subframe by subframe basis.

In many embodiments, there may be a plurality of different D2D subframe types which can allow RX-TX switching time and/or prevent subframe collision at the receiving D2D-UE, depending on the subframe type of a preceding and/or subsequent subframe. In such embodiments, the above method may further comprise:

selecting an appropriate D2D subframe type from among the plurality of different D2D subframe types for use on a given subframe; and
transmitting D2D channel(s) and/or D2D signal(s) from one D2D-UE to another on the given subframe using the selected D2D subframe type.

The method for selecting an appropriate D2D subframe type from among the said plurality of different D2D subframe types may not require signalling between paired or grouped D2D-UEs to indicate the D2D subframe type selected for use in a given subframe.

In a first embodiment (or a group of embodiments forming a first group) the first D2D-UE and second D2D-UE, at least, may be in cellular communication with the same servicing base station. That is, the first D2D-UE and second D2D-UE, at least, may belong to, and be serviced by, one and the same servicing base station.

In the first embodiment (or an embodiment within the first group of embodiments), the plurality of different D2D subframe types may include a first D2D subframe type which is selected for use in transmitting D2D channel(s) and/or D2D signal(s) on a given subframe when:
the immediately preceding subframe is either:
   a D2D subframe of the same connection (i.e. a D2D subframe transmitted between the same D2D-UEs) and with any transmission direction (the transmit or receive direction relative to a particular D2D-UE), or
   a cellular TDD special subframe if the servicing base station is a TDD base station, and
the immediately following subframe is either:
   a D2D subframe of the same transmission direction, or
   a cellular downlink (DL) subframe if the base station is a TDD base station.

The said first D2D subframe type may not have a guard period at the beginning or at the end of the subframe. In the case of normal cyclic prefix (CP) all 14 orthogonal frequency division multiplexing (OFDM) or single carrier frequency division multiple access (SC-FDMA) symbols may be used for transmitting/receiving D2D channel(s) and/or D2D signal(s), or in the case of extended CP all 12 OFDM or SC-FDMA symbols may be used for transmitting/receiving D2D channel(s) and/or D2D signal(s).

Also in the first embodiment (or at least in an embodiment which is again within the first group of embodiments), the plurality of different D2D subframe types may include a second D2D subframe type which is selected for use in transmitting D2D channel(s) and/or D2D signal(s) on a given subframe when:
the immediately preceding subframe is either:
   a D2D subframe of the same connection, or
   a cellular TDD special subframe if the servicing base station is a TDD base station, and
the immediately following subframe is either:
   a D2D subframe of the same connection with opposite transmission direction, or
   a D2D subframe of another connection, or
   a cellular UL subframe if the servicing base station is a TDD base station.

The second D2D subframe type may not have a guard period at the beginning of the subframe but it may have at least one guard period at the end of the subframe. This may assist in handling subframe collision and RX-TX switching. In the case of normal CP the first 13 OFDM or SC-FDMA symbols may be used for transmitting/receiving D2D channel(s) and/or D2D signal(s), or in the case of extended CP the first 11 OFDM or SC-FDMA symbols may be used for transmitting/receiving D2D channel(s) and/or D2D signal(s), and for both normal CP and extended CP the last OFDM or SC-FDMA symbol in the subframe may be discontinuous transmission (DTX).

Again in the first embodiment (or at least in an embodiment which is again within the first group of embodiments), the plurality of different D2D subframe types may include a third D2D subframe type which is selected for use in transmitting D2D channel(s) and/or D2D signal(s) on a given subframe when:
the immediately preceding subframe is a cellular uplink (UL) subframe, and
the immediately following subframe is either:
   a D2D subframe of the same connection with the same transmission direction, or
   a cellular DL subframe if the servicing base station is a TDD base station.

The third D2D subframe type may not have a guard period at the end of the subframe but it may have at least one guard period at the start of the subframe. This may assist in handling RX-TX switching. In the case of normal CP the last 13 OFDM or SC-FDMA symbols may be used for transmitting/receiving D2D channel(s) and/or D2D signal(s), or in the case of extended CP the last 11 OFDM or SC-FDMA symbols may be used for transmitting/receiving D2D channel(s) and/or D2D signal(s), and for both normal CP and extended CP the first OFDM or SC-FDMA symbol may be DTX.

Yet again in the first embodiment (or at least in an embodiment which is again within the first group of embodiments), the plurality of different D2D subframe types may include a fourth D2D subframe type which is selected for use in transmitting D2D channel(s) and/or D2D signal(s) on a given subframe when:
the immediately preceding subframe is a cellular UL subframe, and
the immediately following subframe is either:
   a D2D subframe of the same connection with opposite transmission direction, or
   a D2D subframe of another connection, or
   a cellular UL subframe.

The fourth D2D subframe type may have at least one guard period at the start of the subframe (this may assist in handling TX-RX switching time) and also at least one guard period at the end of the subframe (this may assist in handling subframe collision and RX-TX switching). In the case of normal CP the 2nd to 13th OFDM or SC-FDMA symbols may be used for transmitting/receiving D2D channel(s) and/or D2D signal(s), or in the case of extended CP the 2nd to 11th OFDM or SC-FDMA symbols may be used for transmitting/receiving D2D channel(s) and/or D2D signal(s), and for both normal CP and extended CP the first and last OFDM or SC-FDMA symbol in a D2D subframe may be DTX.

In the first embodiment, transmitting one or a plurality of the different D2D subframe types may optionally include applying a retard or offset, possibly for half of the network configured TA in comparison with the network configured cellular UL subframe reference timing. This may help to bring D2D-UE transmit and D2D-UE receive into approximate D2D subframe reference timing alignment.

In a second embodiment (or a group of embodiments forming a second group), the first D2D-UE and second D2D-UE, at least, may be in cellular communication with different servicing base stations.

In the second embodiment (or an embodiment within the second group of embodiments), the plurality of different D2D subframe types may include a first D2D subframe type which is selected for use in transmitting D2D channel(s) and/or D2D signal(s) on a given subframe when:
the immediately preceding subframe is a D2D subframe, and
the immediately following subframe is a D2D subframe of the same connection and transmission direction.

The said first D2D subframe type may not have a guard period at the beginning or at the end of the subframe. In the case of normal CP all 14 OFDM or SC-FDMA symbols may be used for transmitting/receiving D2D channel(s) and/or D2D signal(s), or in the case of extended CP all 12 OFDM or SC-FDMA symbols may be used for transmitting/receiving D2D channel(s) and/or D2D signal(s).

Also in the second embodiment (or at least in an embodiment which is again within the second group of embodiments), the plurality of different D2D subframe types may include a second D2D subframe type which is selected for use in transmitting D2D channel(s) and/or D2D signal(s) on a given subframe when:
the immediately preceding subframe is a D2D subframe, and
the immediately following subframe is either:
   a D2D subframe of the same connection but with the opposite transmission direction, or
   a D2D subframe of another connection, or
   a cellular subframe, including a cellular UL subframe or a cellular DL subframe.

The second D2D subframe type may not have a guard period at the start of the subframe but it may have at least one guard period at the end. This may assist in handling subframe collision and RX-TX switching. In the case of normal CP the first 12 OFDM or SC-FDMA symbols may be used for transmitting/receiving D2D channel(s) and/or D2D signal(s) and the last two symbols may be DTX, or in the case of extended CP the first 11 OFDM or SC-FDMA symbols may be used for transmitting/receiving D2D channel(s) and/or D2D signal(s) and the last symbol may be DTX.

Again in the second embodiment (or at least in an embodiment which is again within the second group of embodiments), the plurality of different D2D subframe types may include a third D2D subframe type which is selected for use in transmitting D2D channel(s) and/or D2D signal(s) on a given subframe when:
the immediately preceding subframe is a cellular subframe, including a cellular FDD subframe or a cellular TDD special subframe, and
the immediately following subframe is a D2D subframe of the same connection with the same transmission direction.

The third D2D subframe type may not have a guard period at the end of the subframe but it may have at least one guard period at the start of the subframe (this may assist in handling subframe collision and RX-TX switching). In the case of normal CP the last 13 OFDM or SC-FDMA symbols may be used for transmitting/receiving D2D channel(s) and/or D2D signal(s), or in the case of extended CP the last 11 OFDM or SC-FDMA symbols may be used for transmitting/receiving D2D channel(s) and/or D2D signal(s), and for both normal and extended CP the first symbol may be DTX.

Yet again in the second embodiment (or at least in an embodiment which is again within the second group of embodiments), the plurality of different D2D subframe types may include a fourth D2D subframe type which is selected for use in transmitting D2D channel(s) and/or D2D signal(s) on a given subframe when:
the immediately preceding subframe is a cellular subframe, and
the immediately following subframe is either:
   a D2D subframe of the same connection with opposite transmission direction, or
   a D2D subframe of another connection, or
   a cellular subframe, including a cellular UL or DL subframe.

The fourth D2D subframe type may have at least one guard period at the start of the subframe (this may assist in handling subframe collision and TX-RX switching time) and at least one guard period at the end of the subframe (this may assist in handling subframe collision and RX-TX switching). In the case of normal CP the first OFDM or SC-FDMA symbol may be DTX, the 2nd to 12th OFDM or SC-FDMA symbols may be used for transmitting/receiving D2D channel(s) and/or D2D signal(s) and the last two OFDM or SC-FDMA symbols may be DTX, or in the case of extended CP the first OFDM or SC-FDMA symbol may be DTX, the 2nd to 11th OFDM or SC-FDMA symbols may be used for transmitting/receiving D2D channel(s) and/or D2D signal(s) and the last OFDM or SC-FDMA symbol may be DTX.

Further in the second embodiment (or at least in an embodiment which is again within the second group of embodiments), the different base stations servicing the first D2D-UE and the second D2D-UE respectively may both be TDD base stations, and the plurality of different D2D subframe types may include a fifth D2D subframe type which is selected for use in transmitting D2D channel(s) and/or D2D signal(s) on a given subframe when:
the immediately preceding subframe is a certain cellular special subframe (such as subframe #1), and
the immediately following subframe is either:
   a D2D subframe of the same connection but with opposite transmission direction, or
   a D2D subframe of another connection, or
   a cellular subframe.

The fifth D2D subframe type may have a guard period at the start of the subframe (this may assist in handling subframe collision) and at least one guard period at the end of the subframe (this may assist in handling subframe collision and RX-TX switching). In the case of normal CP the first 12 OFDM or SC-FDMA symbols may be used for transmitting/receiving D2D channel(s) and/or D2D signal(s), the last two OFDM or SC-FDMA symbols may be DTX and a retardation may be applied to save one OFDM/SC-FDMA symbol, or in the case of extended CP the first OFDM/SC-FDMA symbol may be DTX, the 2nd to 11th OFDM or SC-FDMA symbols may be used for transmitting/receiving D2D channel(s) and/or D2D signal(s) and the last OFDM/SC-FDMA symbol may be DTX.

In the second embodiment, transmitting one or a plurality of the different D2D subframe types may optionally include applying a retard or offset, possibly for half of the network configured TA in comparison with the network configured cellular UL subframe reference timing. This may help to bring D2D-UE transmit and D2D-UE receive into approximate D2D subframe reference timing alignment.

The following is a further discussion of the invention (or aspects or embodiments thereof). In some areas, the discussion below may use slightly different wording/nomenclature to that used above, or it may present the invention (or aspects or embodiments thereof) from a slightly different perspective.

In one form of the invention at least, a method is proposed for implementation by D2D capable UEs (so called D2D-UEs) in D2D communication which may assist in managing and/or resolving intra-UE collision and/or inter-UE interference due to, for example, timing misalignment. This may help to enable direct communication to achieve higher end-user data rates in comparison to traditional cellular communication (alone). The method may also help to allow D2D communication sharing the same UL resource, or UL subframes dynamically, on a subframe by subframe basis.

In many embodiments, the method involves selecting an appropriate D2D subframe type from among a number of specially designed subframe types, and transmitting the selected D2D subframe type carrying D2D channel(s) and/or D2D signal(s) from a first D2D-UE to (a) second D2D-UE(s), wherein the D2D-UEs may belong to the same cellular servicing base station or different cellular servicing base stations. The method for selecting the appropriate D2D subframe type from among the said number of specially designed subframe types for transmitting D2D channel(s) and/or D2D signal(s) is preferably transparent (i.e. inherently understood by all D2D-UEs), thus eliminating the need for any signalling to inform a receiving D2D-UE in a D2D-UE pair/group of the particular (appropriate) specially designed subframe type used in a given instance.

In the transmission and reception of D2D subframe(s) between or among D2D-UEs which form a pair or group for D2D communication and which are under the same cell coverage or the same servicing base station, the said servicing base station may be FDD or TDD.

In the transmission and reception of D2D subframe(s) between or among D2D-UEs which form a pair or group for D2D communication and which are under different cell coverage or different servicing base stations, the said servicing base stations may be of FDD and FDD respectively, TDD and TDD respectively, or FDD and TDD respectively. Due to imperfect timing synchronisation, there may be a timing offset (which may be up to a maximum of 10 μsecs in practical implementations) between or among the servicing base stations.

In a first aspect of the invention, the first D2D-UE and second D2D-UE(s) that together form a pair (or group) for direct communication utilising cellular FDD UL resource or TDD UL subframes, belong to the same servicing base station. That is, the said servicing base station provides cell coverage to both the first D2D-UE and the second D2D-UE(s). Prior to transmitting and receiving D2D subframes in D2D communication, the first D2D-UE and second D2D-UE(s) may be implicitly or explicitly informed that the D2D-UEs in the pair (or group) have the same cell coverage in order to allow determination/selection of the correct/appropriate (specially designed) D2D subframe type for use in transmitting and receiving D2D channel(s) and/or D2D signal(s). The correct/appropriate D2D subframe type for transmitting D2D channel(s) and/or signal(s) on a particular cellular UL subframe may be determined/selected by the transmitting D2D-UE, and the paired (grouped) receiving D2D-UE(s) may implicitly understand which D2D subframe type is selected in order to perform correct reception and decoding of the D2D channel(s) and/or signal(s).

As mentioned above, there may be a number of subframe types which are specially designed for use in selected D2D subframes carrying D2D channel(s) and/or D2D signal(s) from one D2D-UE to another. In the first aspect of the invention presently being discussed, there may be four such specially designed subframe types.

The first of these specially designed D2D subframe types may be used by a transmitting D2D-UE when its immediately prior subframe is either a D2D subframe or a cellular special subframe if cellular TDD UL subframe(s) are being shared for D2D communication, and its immediately coming subframe is either a D2D subframe of the same connection with the same transmission direction or a cellular DL subframe if cellular TDD UL subframe(s) are being shared for D2D communication. For normal cyclic prefix (CP), this first D2D subframe type may comprise 14 OFDM or SC-FDMA symbols allocated for mapping of D2D channel(s) and/or D2D signal(s). For extended CP, this first D2D subframe type may comprise 12 OFDM or SC-FDMA symbols allocated for mapping of D2D channel(s) and/or D2D signal(s).

In the first aspect of the invention, the second of the specially designed D2D subframe types may be used by a transmitting D2D-UE when its immediately prior subframe is either a D2D subframe or a cellular special subframe if cellular TDD UL subframe(s) are being shared for D2D communication, and its immediately coming subframe is a D2D subframe of the same connection with opposite transmission direction, a D2D subframe of another connection, or cellular UL subframe. For normal CP, this second D2D subframe type may comprise 14 OFDM or SC-FDMA symbols with the first 13 symbols being allocated for mapping of D2D channel(s) and/or D2D signal(s) and the last symbol being DTX. For extended CP, this second D2D subframe type may comprise 12 OFDM or SC-FDMA symbols with the first 11 symbols being allocated for mapping of D2D channel(s) and/or D2D signal(s) and the last symbol being DTX.

In the first aspect of the invention, the third of the specially designed D2D subframe types may be used by a transmitting D2D-UE when its immediately prior subframe is cellular UL subframe, and its immediately coming subframe is either a D2D subframe of same connection with same transmission direction or a cellular TDD DL subframe if cellular TDD UL subframe(s) are being shared for D2D communication. For normal CP, this third D2D subframe type may comprise 14 OFDM or SC-FDMA symbols with the first symbol being DTX and the following 13 symbols being allocated for mapping of D2D channel(s) and/or D2D signal(s). For extended CP, this third D2D subframe type may comprise 12 OFDM or SC-FDMA symbols with the first symbol being DTX and the following 11 symbols being allocated for mapping of D2D channel(s) and/or D2D signal(s).

In the first aspect of the invention, the fourth of the specially designed D2D subframe types may be used by a transmitting D2D-UE when its immediately prior subframe is a cellular UL subframe, and its immediately coming subframe is a D2D subframe of the same connection with opposite transmission direction, or a D2D subframe of another connection, or a cellular UL subframe. For normal CP, this fourth D2D subframe type may comprise 14 OFDM or SC-FDMA symbols with the first symbol being DTX, the 2nd to 13th symbols being allocated for mapping of D2D channel(s) and/or D2D signal(s) and the last symbol being DTX. For extended CP, this fourth D2D subframe type comprises 12 OFDM or SC-FDMA symbols with the first symbol being DTX, the 2nd to 11th symbols being allocated for mapping of D2D channel(s) and/or D2D signal(s) and the last symbol being DTX.

In a second aspect of the invention, the first D2D-UE and second D2D-UE(s) which together form a pair (or group) for direct communication utilising cellular FDD UL resource or TDD UL subframes, belong to different servicing base stations. That is, for example, a first servicing base station may provide cell coverage to the first D2D-UE and a second servicing base station may provide cell coverage to a second D2D-UE. Prior to transmitting and receiving D2D subframes in D2D communication, the first D2D-UE and the second D2D-UE(s) may be implicitly or explicitly informed that the pair (or group) have different cell coverage and services in order to allow determination/selection of the correct/appropriate (specially designed) D2D subframe type for use in transmitting and receiving D2D channel(s) and/or D2D signal(s). Just like in the first aspect of the invention above, the correct/appropriate D2D subframe type for transmitting D2D channel(s) and/or signal(s) on a particular cellular UL subframe may be determined/selected by the transmitting D2D-UE, and the paired (or grouped) receiving D2D-UE(s) may implicitly understand which D2D subframe type is selected in order to perform correct reception and decoding of the D2D channel(s) and/or signal(s).

Like in the first aspect of the invention, in the second aspect there may again be a number of subframe types which are specially designed for use in selected D2D subframes carrying D2D channel(s) and/or D2D signal(s) from one D2D-UE to another. In the second aspect of the invention, there may be five such specially designed subframe types.

The first of these specially designed D2D subframe types may be used by a transmitting D2D-UE when its immediately prior subframe is a D2D subframe, and its immediately coming subframe is a D2D subframe of the same connection with same transmission direction. For normal CP, this first D2D subframe type may comprise 14 OFDM or SC-FDMA symbols being allocated for mapping of D2D channel(s) and/or D2D signal(s). For extended CP, this first D2D subframe type may comprise 12 OFDM or SC-FDMA symbols allocated for mapping of D2D channel(s) and/or D2D signal(s).

In the second aspect of the invention, the second of the specially designed D2D subframe types may be used by a transmitting D2D-UE when its immediately prior subframe is a D2D subframe, and its immediately coming subframe is D2D subframe of the same connection with opposite transmission direction, or a D2D subframe of a different connection, or a cellular UL subframe. For normal CP, this second D2D subframe type may comprise 14 OFDM or SC-FDMA symbols with the first 12 symbols being allocated for mapping of D2D channel(s) and/or D2D signal(s) and the last two symbols being DTX. For extended CP, this second D2D subframe type may comprise 12 OFDM or SC-FDMA symbols with the first 11 symbols being allocated for mapping of D2D channel(s) and/or D2D signal(s) and the last symbol being DTX.

In the second aspect of the invention, the third of the specially designed D2D subframe types may be used by a transmitting D2D-UE when its immediately prior subframe is a cellular subframe, and its immediately coming subframe is a D2D subframe of same connection with same transmission direction. For normal CP, this third D2D subframe type may comprise 14 OFDM or SC-FDMA symbols with the first symbol being DTX and the following 13 symbols being allocated for mapping of D2D channel(s) and/or D2D signal(s). For extended CP, this third D2D subframe type may comprise 12 OFDM or SC-FDMA symbols with the first symbol being DTX and the following 11 symbols being allocated for mapping of D2D channel(s) and/or D2D signal(s).

In the second aspect of the invention, the fourth of the specially designed D2D subframe types may be used by a transmitting D2D-UE when its immediately prior subframe is a cellular subframe, and its immediately coming subframe is a D2D subframe of same connection with opposite transmission direction, or a D2D subframe of another connection, or a cellular subframe. For normal CP, this fourth D2D subframe type may comprise 14 OFDM or SC-FDMA symbols with the first symbol being DTX, the 2nd to 12th symbols being allocated for mapping of D2D channel(s) and/or D2D signal(s) mapping and the last two symbols being DTX. For extended CP, this fourth D2D subframe type may comprise 12 OFDM or SC-FDMA symbols with the first symbol being DTX, the 2nd to 11th symbols being allocated for mapping of D2D channel(s) and/or D2D signal(s) and the last symbol being DTX.

In the second aspect of the invention, the fifth of the specially designed D2D subframe types may be used by a transmitting D2D-UE only in situations where both the first base station and the second base station are TDD and when its immediately prior subframe is a certain (i.e. it is known to be a) cellular TDD special subframe, and its immediately coming subframe is a D2D subframe of the same connection with opposite transmission direction, or a D2D subframe of another connection, or a cellular subframe. For normal CP, this fifth D2D subframe type may comprise 14 OFDM or SC-FDMA symbols with the first 12 symbols being allocated for mapping of D2D channel(s) and/or D2D signal(s) and the last two symbols being DTX, and at the transmitting D2D-UE the fifth D2D subframe type is retarded (preferably for a LTE sample timing unit, which may be 1644 Ts) relative to the start of the corresponding cellular UL subframe. For extended CP, this fifth D2D subframe type may comprises 12 OFDM or SC-FDMA symbols with the first symbol being DTX, the 2nd to 11th symbols being allocated for mapping of D2D channel(s) and/or D2D signal(s) and the last symbol being DTX.

Any of the features described herein can be combined in any combination with any one or more of the other features described herein within the scope of the invention.

### Advantageous Effects of Invention

The present invention may help to resolve or manage intra-UE collision and inter-UE interference due to, for instance, timing misalignment, and may hence help to allow cellular communication and D2D communication sharing the same resource on a subframe basis.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 schematically illustrates an advanced wireless communication system in which UEs that are transmitting and receiving D2D subframe(s) from one another are serviced by a single cellular base station.

FIG. 2 schematically illustrates an advanced wireless communication system in which UEs that are transmitting and receiving D2D subframe(s) from one another are serviced by different cellular base stations.

FIG. 3A contains a schematic illustration of a wireless communication system, and a related timing analysis diagram, for the situation of D2D communication between UEs serviced by a single cellular FDD base station.

FIG. 3B contains a schematic illustration of a wireless communication system, and a related timing analysis diagram, for the situation of D2D communication between UEs serviced by a single cellular FDD base station.

FIG. 4A contains a schematic illustration of a wireless communication system, and a related timing analysis diagram, for the situation of D2D communication between UEs serviced by a single cellular TDD base station.

FIG. 4B contains a schematic illustration of a wireless communication system, and a related timing analysis diagram, for the situation of D2D communication between UEs serviced by a single cellular TDD base station.

FIG. 5A contains a schematic illustration of a wireless communication system, and a related timing analysis diagram, for the situation of D2D communication between UEs serviced by two cellular FDD base stations.

FIG. 5B contains a schematic illustration of a wireless communication system, and a related timing analysis diagram, for the situation of D2D communication between UEs serviced by two cellular FDD base stations.

FIG. 5C contains a schematic illustration of a wireless communication system, and a related timing analysis diagram, for the situation of D2D communication between UEs serviced by two cellular FDD base stations.

FIG. 6A contains a schematic illustration of a wireless communication system, and a related timing analysis diagram, for the situation of D2D communication between UEs serviced by two cellular TDD base stations.

FIG. 6B contains a schematic illustration of a wireless communication system, and a related timing analysis diagram, for the situation of D2D communication between UEs serviced by two cellular TDD base stations.

FIG. 6C contains a schematic illustration of a wireless communication system, and a related timing analysis diagram, for the situation of D2D communication between UEs serviced by two cellular TDD base stations.

FIG. 7A contains schematic illustrations of wireless communication systems, and respective related timing analysis diagrams, for situations of D2D communication between UEs serviced by two cellular base stations; in one case the first base station is FDD and the second base station is TDD, and in the other case the first base station is TDD and the second base station is FDD.

FIG. 7B contains schematic illustrations of wireless communication systems, and respective related timing analysis diagrams, for situations of D2D communication between UEs serviced by two cellular base stations; in one case the first base station is FDD and the second base station is TDD, and in the other case the first base station is TDD and the second base station is FDD.

FIG. 7C contains schematic illustrations of wireless communication systems, and respective related timing analysis diagrams, for situations of D2D communication between UEs serviced by two cellular base stations; in one case the first base station is FDD and the second base station is TDD, and in the other case the first base station is TDD and the second base station is FDD.

FIG. 7D contains schematic illustrations of wireless communication systems, and respective related timing analysis diagrams, for situations of D2D communication between UEs serviced by two cellular base stations; in one case the first base station is FDD and the second base station is TDD, and in the other case the first base station is TDD and the second base station is FDD.

FIG. 7E contains schematic illustrations of wireless communication systems, and respective related timing analysis diagrams, for situations of D2D communication between UEs serviced by two cellular base stations; in one case the first base station is FDD and the second base station is TDD, and in the other case the first base station is TDD and the second base station is FDD.

FIG. 8 graphically represents a proposed type 1 subframe structure for D2D communication.

FIG. 9 illustrates the application of the type 1 subframe structure.

FIG. 10 graphically represents a proposed type 2 subframe structure for D2D communication.

FIG. 11 illustrates the application of the type 2 subframe structure.

FIG. 12 graphically represents a proposed type 2″ subframe structure for D2D communication.

FIG. 13 illustrates the application of the type 2″ subframe structure.

FIG. 14 graphically represents a proposed type 3 subframe structure for D2D communication.

FIG. 15 illustrates the application of the type 3 subframe structure.

FIG. 16 graphically represents a proposed type 4 subframe structure for D2D communication.

FIG. 17 illustrates the application of the type 4 subframe structure.

FIG. 18 graphically represents a proposed type 4″ subframe structure for D2D communication.

FIG. 19 illustrates the application of the type 4″ subframe structure.

FIG. 20 graphically represents a proposed type 5 subframe structure for D2D communication.

FIG. 21 illustrates the application of the type 5 subframe structure.

### DESCRIPTION OF EMBODIMENTS

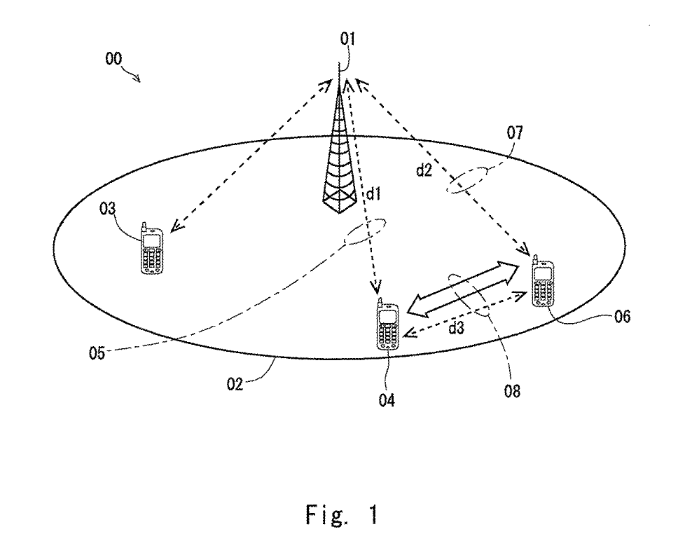

FIG. 1 helps to illustrate a wireless communication system and a method for transmitting and receiving D2D subframes. FIG. 1 also depicts certain associated apparatus with reference to which certain embodiments of the invention will be analysed and discussed. The wireless communication system 00 in FIG. 1 is a single-cell cellular network comprising an access node 01 representing a cellular base station which provides coverage 02 and services a plurality of user equipments (UEs) 03, 04, and 06 which are operating within coverage 02. The base station may operate using FDD or TDD. Hence, the wireless communication system 00 may be a FDD or a TDD system.

Among the plurality of UEs, there may be multiple UEs that are be capable of performing both cellular communication and also direct (or so called D2D) communication, such as UEs 04 and 06. Such UEs may be referred to as D2D-UEs. D2D-UEs 04 and 06 may happen to be within close proximity of each other (i.e. separated by a distance d3 (08)), they may be able to discover each other, and they may be configured or at least allowed by their servicing base station 01 to use cellular UL resources to directly communicate with each other. While directly communicating with each other, paired D2D-UEs 04 and 06 are required to use their own cellular UL timing as reference timing for transmitting D2D subframe(s). A UE UL timing used in cellular communication is provided by the servicing base station in the form of a timing advance (TA). According to previously proposed 3GPP LTE, TA is configured based on the distance between a servicing base station and a communicating UE; such as for example distance d1 (05) for UE 04, and distance d2 (07) for UE 06, in FIG. 1.

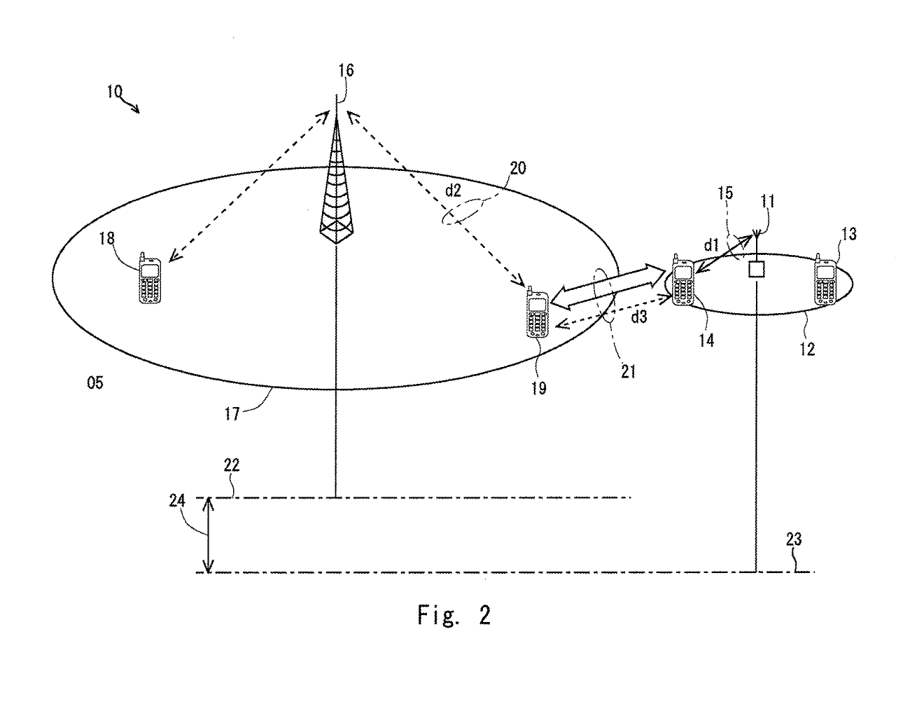

D2D communication is also possible for D2D capable UEs (D2D-UEs) belonging to different servicing base stations. FIG. 2 helps to illustrate this. In FIG. 2, the wireless communication system 10 is an extension of cellular network 00 above in that wireless communication system 10 comprises a plurality access nodes, namely access node 11 representing a cellular base station having coverage 12 and providing services to a plurality of UEs 13, 14 operating within coverage 12, and also access node 16 which represents another cellular base station having coverage 17 and providing services to a plurality of UEs 18, 19 operating within coverage 17. The said servicing base stations 11 and 16 may both be FDD, or both TDD, or one may be FDD and the other TDD. They may also operate on the same carrier frequency or different carrier frequencies.

Among the plurality of UEs, there may be multiple UEs, such as for example D2D-UE 14 belonging to servicing base station 11 and D2D-UE 19 belonging to servicing base station 16, that are be capable of performing cellular communication and also D2D communication. These D2D-UEs may happen to be within close proximity of each other (i.e. separated by a distance d3 (21)), they may be able to discover each other, and they may be configured or at least allowed (each by its own servicing base station 11 or 16) to use a selected cellular UL resource to directly communicate with each other. While directly communicating with each other, each of paired D2D-UEs 14 and 19 is required to use its own cellular UL timing as reference timing for transmitting D2D subframe(s). As noted above, a UE's UL timing used in cellular communication is configured by its servicing base station as a TA, and according to previously proposed 3GPP LTE, the TA is configured based on the distance between the servicing base station and the UE, such as for example distance d1 (15) for D2D-UE 14, and distance d2 (20) for D2D-UE 19, in FIG. 2.

Furthermore, a base station such as base station 11 may have reference timing 23, and another base station such as base station 16 may have another reference timing 22. Due to imperfect system timing synchronisation, reference timing 22 and reference timing 23 may have a timing offset 24 (this may be e.g. 3-10 μsec) to either advance or retard and such a timing offset may introduce additional and potentially unpredictable timing misalignment, as discussed below.

A first aspect of the present invention relates to a method and a D2D subframe structure for sending and receiving a D2D channel(s) and/or D2D signal(s) in such a way as to avoid or at least help to manage intra-UE collision and/or inter-UE interference, and which allows paired D2D-UEs to negotiate dynamic selection of any UL subframe in a radio frame for D2D communication while maintaining their cellular UL transmission, in a system where paired D2D communicating UEs belong to the same servicing base station. The said servicing base station may provide services for FDD communication or TDD communication.

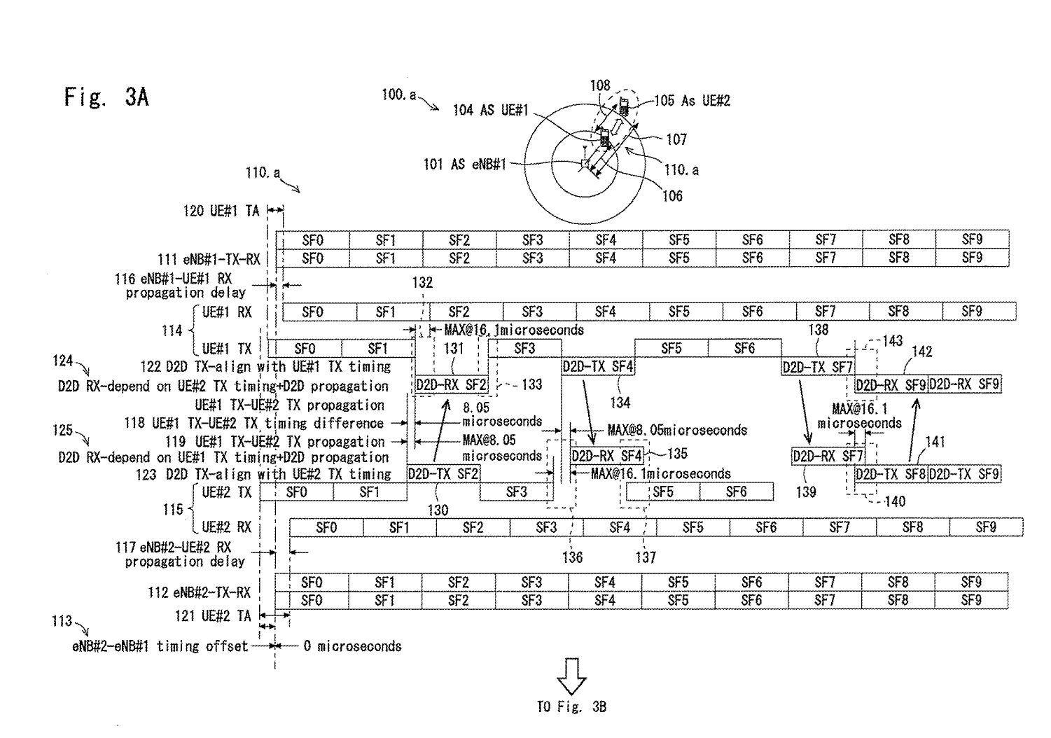

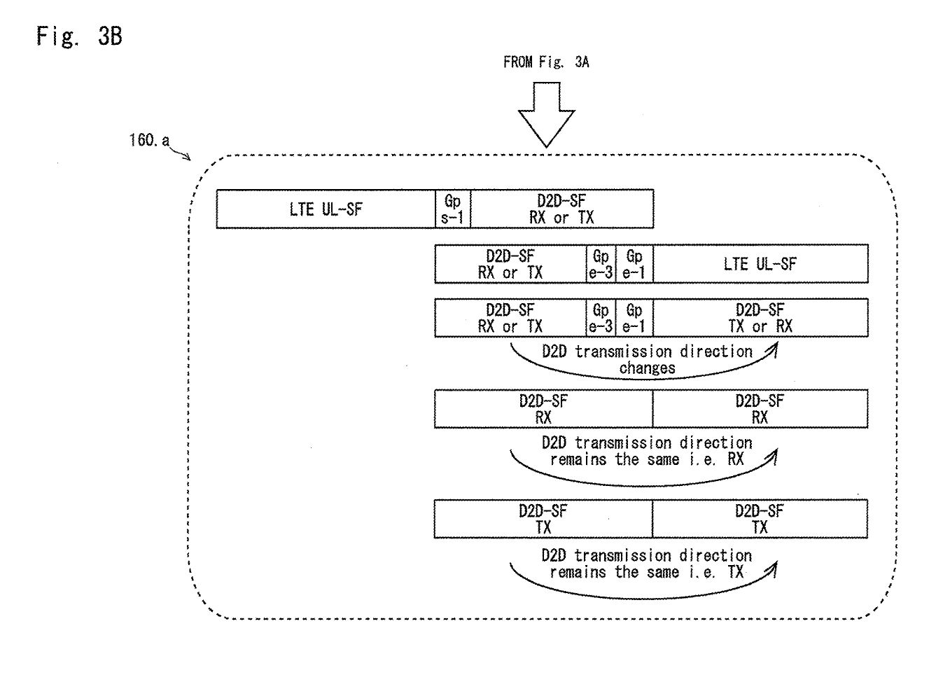

FIGS. 3A and 3B illustrates, among other things, a system 100.a which represents a worst case scenario wherein maximum D2D subframe collision and/or interference occurs in a FDD system. In FIGS. 3A and 3B, D2D-UEs 104 and 105 which form a pair for D2D communication are separated by a maximum allowed distance 108. (In practical implementations, the maximum allowed distance may be 1.5 miles.) D2D-UE 105 is also located at a position such that the distance 107 between the FDD servicing base station 101 and FDD D2D-UE 105 is equal to the distance 106 between the FDD servicing base station 101 and FDD D2D-UE 104 plus distance 108 between FDD D2D-UE 104 and FDD D2D-UE 105. A timing diagram 110.a representing transmitting and receiving cellular subframes and transmitting and receiving D2D subframes in this scenario is also illustrated in FIGS. 3A and 3B and discussed below.

In timing diagram 110.a (which relates to the scenario depicted as 100.a in FIGS. 3A and 3B discussed immediately above), the FDD base station (eNB#1) TX-RX timing 111 servicing FDD D2D-UE 104 is the same as the FDD base station (eNB#2) TX-RX timing 112 servicing FDD D2D-UE 105, because D2D-UEs 104 and 105 belong to a single (i.e. one and the same) servicing base station 101. In other words, eNB#1 and eNB#2 are one and the same in this situation. (Recall that, in the first aspect of the invention presently being discussed, paired D2D communicating UEs belong to the same servicing base station.)

The distance 106 results in a propagation delay 116 for a cellular DL subframe transmitted from the serving base station 101 to D2D-UE 104. For a SC-FDMA symbol sent by all UE(s) and arriving at the serving base station 101 within a CP length, the servicing base station 101 configures D2D-UE 104 to have TA 120 that results in UL subframe timing 114. (According to subframe timing 114, at least in simplistic terms, the D2D-UE 104 (UE#1) basically transmits a cellular uplink subframe slightly earlier than its servicing base station (eNB#1) reference timing to allow for the time taken for the transmission to travel to and reach the base station (eNB#1), and the D2D-UE 104 (UE#1) is configured to receive a cellular downlink subframe from the base station (eNB#1) slightly later in due to the time taken for that transmission to travel the distance from the base station.)

Similarly, the distance 107 results in a propagation delay 117 for a cellular DL subframe transmitted from the serving base station 101 to D2D-UE 105. For a SC-FDMA symbol sent by all UE(s) and arriving at the serving base station 101 within a CP length, the servicing base station 101 configures D2D-UE 105 to have TA 121 which results in UL subframe timing 115. (Again, at least in simplistic terms, subframe timing 115 means that the D2D-UE 105 (UE#2) transmits a cellular uplink subframe earlier than its servicing base station (eNB#2) reference timing to allow for the time taken for the transmission to travel to and reach the base station, and the D2D-UE 105 (UE#2) is configured to receive a cellular downlink subframe from the base station later due to the time taken for the transmission to travel the distance from the base station. Note that a transmission from D2D-UE 105 to the base station under subframe timing 115 begins earlier than a transmissions from D2D-UE 104 to the base station under subframe timing 114, and reception of a transmission from the base station by D2D-UE 105 under subframe timing 115 begins later than reception of a transmission from the base station by D2D-UE 104 under subframe timing 114. This is because D2D-UE 105 (UE#2) is further away from the base station than D2D-UE 104 (UE#1) meaning that transmissions to and from D2D-UE 105 (UE#2) take longer.)

The arrangement described above results in D2D-UEs 104 and 105 having a TX timing difference of 118. The difference is 8.05 μsec in this particular example, and this happens to be the same as the propagation delay 119 between D2D-UE 104 and D2D-UE 105. According to a current working assumption endorsed in the above 3GPP D2D SI, cellular UL subframe timing is used as reference timing for sending D2D subframes (see 122 and 123), and this makes the timing of D2D RX (see 124 and 125) at the receiving D2D-UE (104 and 105) depend on the timing of D2D TX from the transmitting D2D-UE (105 and 104).

The system and associated timing, as described above, provides a basis for discussing the design of a new D2D subframe structure for transmitting and receiving D2D channel(s) and/or D2D signal(s) under an overlaid FDD cellular network.

Still referring to FIGS. 3A and 3B, and randomly selecting cellular UL subframes #2 and #4 for D2D communication, on UL subframe #2 D2D-UE 105 performs transmission of a D2D subframe 130 and D2D-UE 104 then performs reception 131 of that D2D subframe. On cellular UL subframe #4, D2D-UE 104 performs transmission of a D2D subframe 134 and D2D-UE 105 then performs reception 135 of that D2D subframe.

At a D2D subframe transmission site (i.e. the location from which a D2D subframe is transmitted), the start of a transmitted D2D subframe is perfectly aligned in time with the start of the corresponding cellular UL subframe. At the D2D subframe reception site for that D2D subframe (i.e. the location where the said transmitted D2D subframe is received), the received D2D subframe has a subframe start that is later than the start of the corresponding cellular UL subframe start. This is due to the propagation time, and is indicated by for example 136 in FIGS. 3A and 3B. In the worst case scenario though, a received D2D subframe has a subframe start which is aligned in time with the start of the corresponding cellular UL subframe, as indicated by 132.

Transmitting a D2D subframe immediately after transmitting a cellular UL subframe (e.g. 130 or 134 or 138) does not require a D2D-UE to adjust its transmitter. However, receiving a D2D subframe immediately after transmitting an UL cellular subframe (e.g. 131 or 135 or 139) does require a D2D-UE to switch from its transmitter to its receiver. Thus, it is proposed to provide a guard period (GP s-1) at the beginning of a transmitted D2D subframe which immediately follows a cellular UL subframe to account for (or allow for) TX-RX switching time at the D2D receiving site.

Furthermore, at a D2D subframe transmission site, the end of a transmitted D2D subframe is perfectly aligned with the end of the corresponding cellular UL subframe. However, at the D2D subframe reception site for the said subframe, the end of the received D2D subframe may be aligned with the start of a cellular UL subframe transmitted immediately after the said D2D subframe, as indicated by 133, or it may collide or overlap with the start of the cellular UL subframe transmitted immediately after the said D2D subframe, as indicated by 137.

Transmitting a cellular UL subframe immediately after transmitting a D2D subframe (e.g. 130 or 134) does not require a D2D-UE to adjust its transmitter. However, transmitting an UL cellular subframe immediately after receiving a D2D subframe (e.g. 131 or 136) does require a D2D-UE to switch from its receiver to its transmitter. Thus, it is proposed to provide two guard periods (GP e-3 and GP e-1) at the end of a transmitted D2D subframe, where the said transmitted D2D subframe has an immediately following cellular UL subframe, in order to account for (or allow for or prevent) collision and RX-TX switching time at the corresponding D2D receiving site.

Multiple consecutive cellular UL subframes may be allocated for D2D communication, such as for example subframes #7, 8 and 9 as illustrated in timing diagram 110.a in FIGS. 3A and 3B. Any two consecutive subframes for D2D communication which have the same direction (e.g. D2D-TX 141 or D2D-RX 142) will not require a guard period to account for switching and/or collision handling. However, any two consecutive subframes for D2D communication which are in different directions (e.g. D2D-TX to D2D-RX 143, or D2D-RX to D2D-TX 140) will require a guard period to account for TX-RX or RX-TX switching and collision handling. In the worst case scenario in practical implementations, a guard period for collision handling may take up to 16.1 μsec. Thus, it is proposed to provide two guard periods (GP e-3 and GP e-1) at the end of a transmitted D2D subframe, where the said transmitted D2D subframe has an immediately following D2D subframe in the opposite direction, in order to account for (or allow for or prevent) collision and RX-TX/TX-RX switching time at the corresponding D2D receiving/transmitting site.

The proposed guard periods (GP s-1, and GP e-3 and GP e-1) mentioned above for a D2D subframe structure for a FDD system are graphically represented in diagram 160.a in FIGS. 3A and 3B.

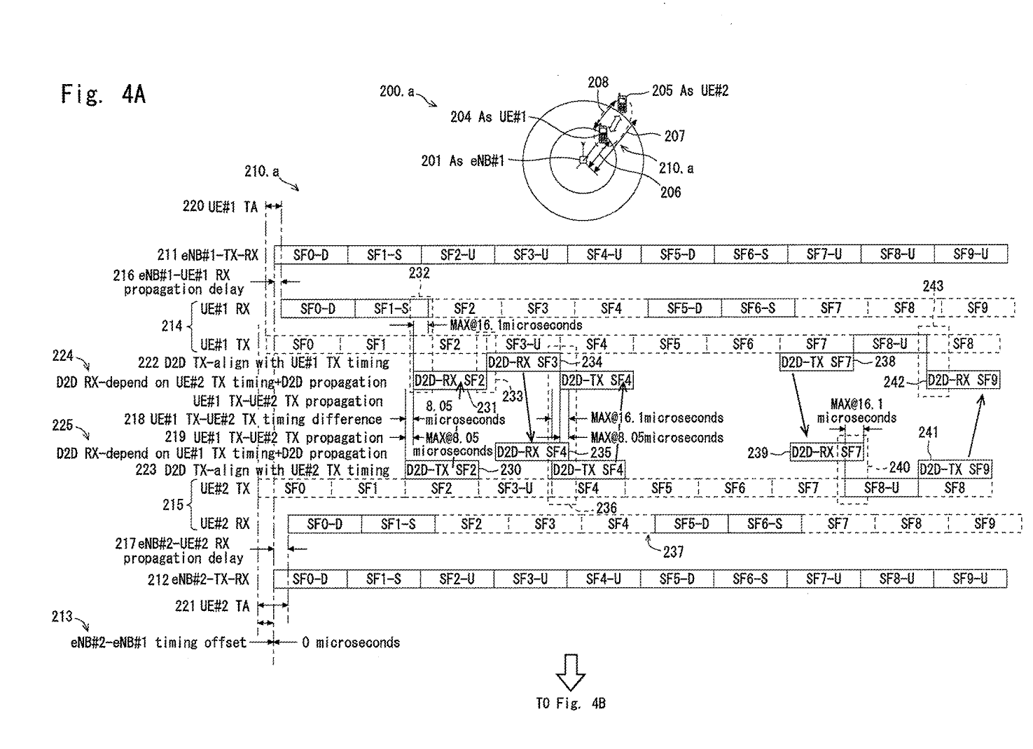

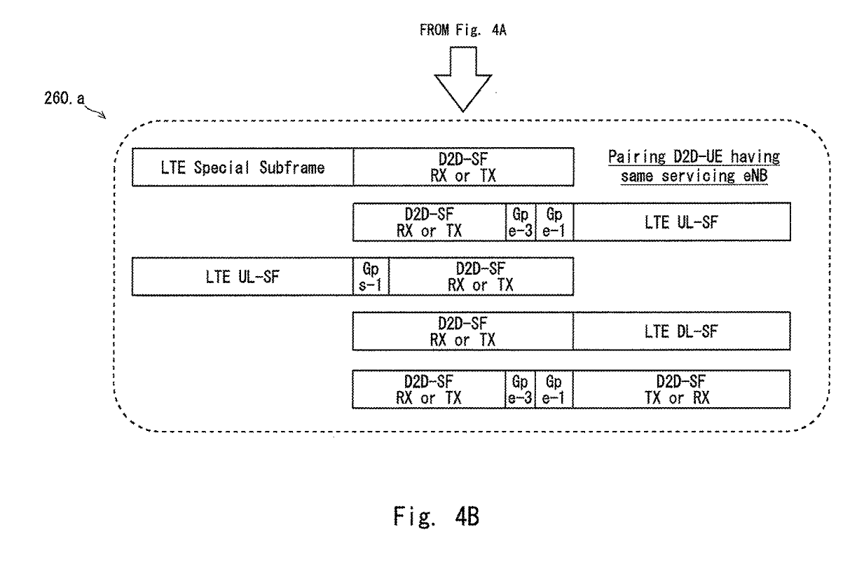

Turning now to FIGS. 4A and 4B, this Figure illustrates, among other things, a system which represents a worst case scenario wherein maximum D2D subframe collision and/or interference occurs in a TDD system (this is different to FIGS. 3A and 3B above which relates to a FDD system). In FIGS. 4A and 4B, TDD D2D-UEs 204 and 205 which form a pair for D2D communication under the overlaid TDD cellular network are separated by a maximum allowed distance 208. (Again, the maximum allowed distance may be 1.5 miles in practical implementations). Also, TDD D2D-UE 205 is located at a position such that the distance 207 between the TDD servicing base station 201 and TDD D2D-UE 205 is equal to the distance 206 between the TDD servicing base station 201 and TDD D2D-UE 404 plus the distance 208 separating TDD D2D-UE 204 and TDD D2D-UE 205. The timing diagram 210.a representing transmitting and receiving cellular subframes and transmitting and receiving D2D subframes in this scenario is also illustrated in FIGS. 4A and 4B.

In the timing diagram 210.a, a similar approach as was applied in the case of the FDD system above is used as a basis for discussing the design of a new D2D subframe structure for transmitting and receiving D2D channel(s) and/or D2D signal(s) under an overlaid TDD cellular network.

Referring to FIGS. 4A and 4B, and selecting cellular UL subframe #2 and/or #7 (both of which follow immediately after a TDD special subframe) for D2D communication, on cellular UL subframe #2 TDD D2D-UE 205 performs transmission of a D2D subframe 230 and TDD D2D-UE 204 then performs reception 231 of that D2D subframe. On cellular UL subframe #7, TDD D2D-UE 204 performs transmission of a D2D subframe 238 and TDD D2D-UE 205 then performs reception 239 of that D2D subframe. At the D2D subframe transmission site, the start of a transmitted D2D subframe is perfectly aligned with the start of the corresponding cellular UL subframe. At the D2D subframe reception site for that subframe, the start of a received D2D subframe is generally later than the start of the corresponding cellular UL subframe, or in the worst case scenario a received D2D subframe has a subframe start which is aligned or overlaps with the corresponding cellular UL subframe, as indicated by 232.

In the case of TDD, transmitting a D2D subframe immediately after receiving a cellular TDD special subframe (e.g. 230 or 238) does not require a TDD D2D-UE to adjust its transmitter as a TDD special subframe is designed to accommodate RX-TX switching. However, receiving a D2D subframe immediately after receiving a cellular TDD special subframe (231 or 239) results in a collision or overlap (for a maximum of 16.1 μsec in practical implementations) between the end of the cellular TDD special subframe and the start of the D2D RX subframe. Technically, the uplink pilot time slot (UpPTS) region designed for use in cellular TDD subframes is sufficient to deal with this overlapping region. Thus, it is proposed that NO guard period is required at the beginning of a transmitted D2D subframe which immediately follows a cellular special subframe to account for TX-RX switching time at the D2D transmitting site or to account for subframe collision at the D2D receiving site.

Similar to the situation in the FDD system discussed above, transmitting a UL cellular subframe immediately after receiving a D2D subframe (e.g. 239-240) results in subframe collision and also requires a D2D-UE to switch from its receiver to its transmitter. Thus, it is proposed to provide two guard periods (GP e-3 and GP e-1) at the end of a transmitted D2D subframe, where the said transmitted D2D subframe has an immediately following cellular UL subframe, to account for collision and RX-TX switching time at the corresponding D2D receiving site.

Also similar to the situation in the FDD system discussed above, multiple consecutive TDD UL cellular subframes may be allocated for D2D communication such as subframes #2, 3 and 4, as illustrated in timing diagram 210.a. Any two consecutive subframes for D2D communication which have the same direction will not require a guard period to account for switching and/or collision handling. However, any two consecutive subframes for D2D communication which have different directions, such as D2D-TX to D2D-RX (234) or D2D-RX to D2D-TX (235), will require guard period to account for RX-TX switching and collision handling. In the worst case scenario in practical implementations, guard period for collision handling may take up to 16.1 μsec (236). Thus, it is proposed to provide two guard periods (GP e-3 and GP e-1) at the end of a transmitted D2D subframe, where the said transmitted D2D subframe has an immediately following D2D subframe with opposite direction, to account for collision and RX-TX switching time at the corresponding D2D receiving site.

The proposed guard periods mentioned above for a D2D subframe structure for a TDD system are graphically represented in diagram 260.a in FIGS. 4A and 4B.

It is to be recalled that the above timing analyses and proposals for transmitting and receiving D2D channel(s) and/or D2D signal(s), as explained with reference to FIGS. 3A, 3B, 4A and 4B, relate to cases where both of the D2D-UEs which form a pair for D2D communication belong to the same servicing base station (which may be a FDD or TDD base station). Four types of D2D subframes are proposed for D2D communication where two D2D UEs which are paired for D2D communication belong to the same cellular servicing base station. These are:

1. Type 1 D2D Subframe

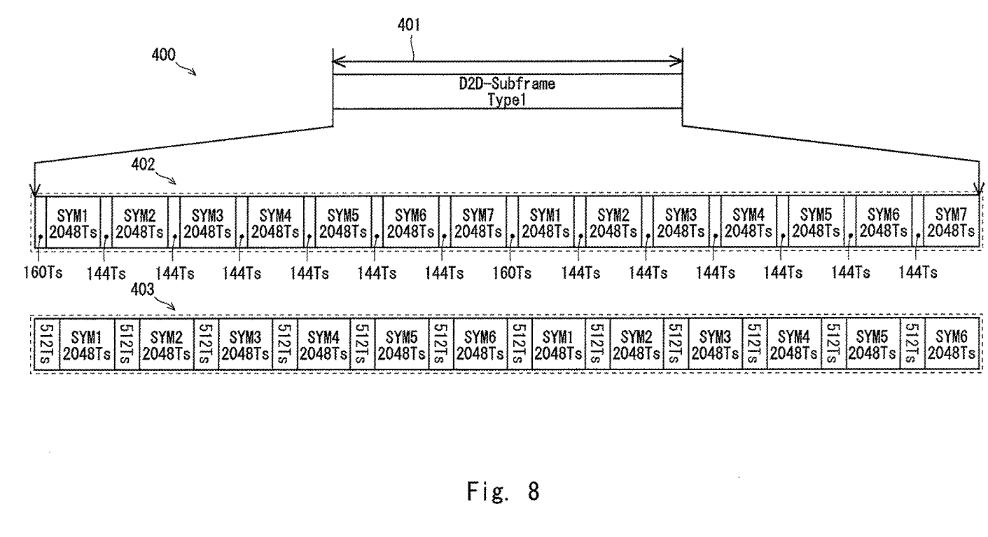

The type 1 D2D subframe 400 is illustrated in FIG. 8. This subframe does not require a guard period either at the beginning or at the end of a D2D subframe 401. In the case of normal CP, all 14 OFDM or SC-FDMA symbols 402 are used for transmitting/receiving D2D channel(s) and/or D2D signal(s). In the case of extended CP, all 12 OFDM or SC-FDMA symbols 403 are used for transmitting/receiving D2D channel(s) and/or D2D signal(s).

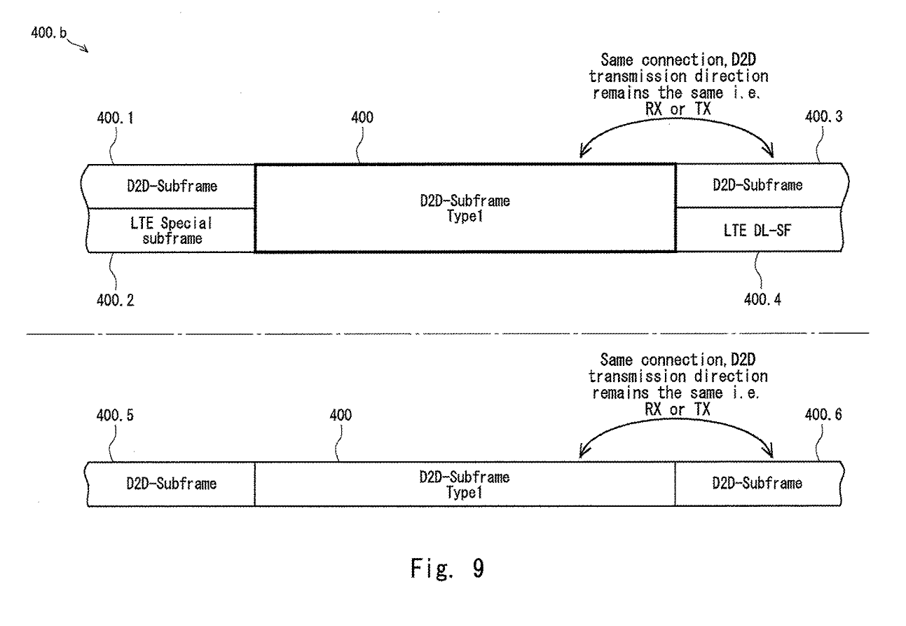

Referring to FIG. 9, in the case where both of the D2D-UEs which form a pair for D2D communication belong to the same servicing base station, and where the said base station is a FDD base station or a TDD base station, the type 1 D2D subframe 400 is used when:

the immediately prior subframe is either a D2D subframe of the same connection with any transmission direction (see 400.1) or a cellular TDD special subframe (see 400.2) if the base station is a TDD base station, and

the immediately following subframe is either a D2D subframe of the same transmission direction (400.3) or a cellular DL subframe (400.4) if the base station is a TDD base station.

2. Type 2″ D2D Subframe

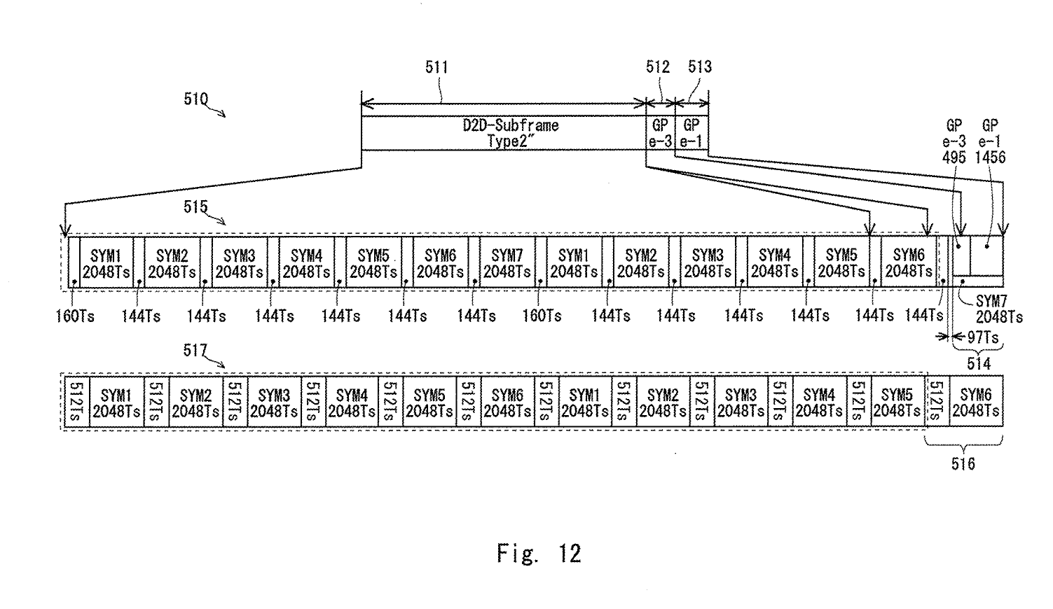

The type 2″ D2D subframe 510 is illustrated in FIG. 12. This subframe type 511 does not require a guard period at the subframe start but does require guard periods 512 and 513 at the subframe end for handling subframe collision and RX-TX switching respectively. In the case of normal CP, the first 13 OFDM or SC-FDMA symbols 515 are used for transmitting/receiving D2D channel(s) and/or D2D signal(s). In the case of extended CP, the first 11 OFDM or SC-FDMA symbols 517 are used for transmitting/receiving D2D channel(s) and/or D2D signal(s). For both normal CP and extended CP, the last OFDM or SC-FDMA symbol in the subframe is discontinuous transmission (DTX).

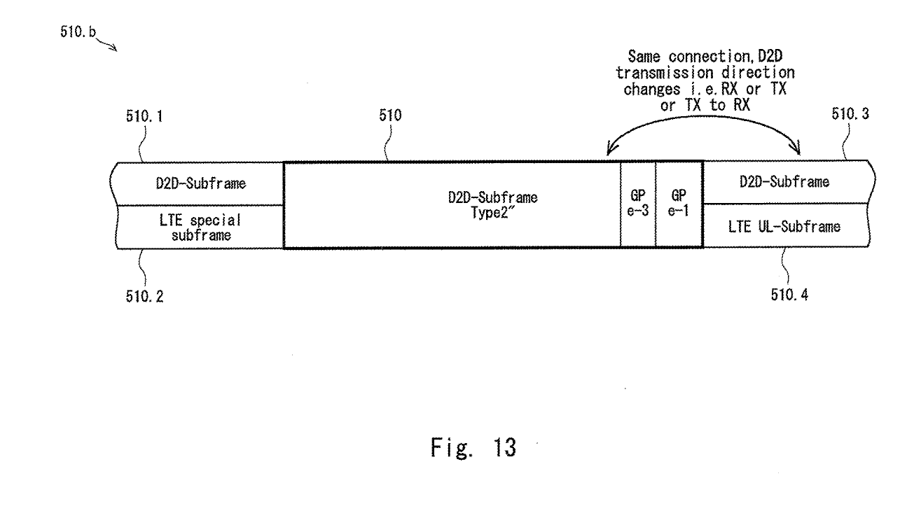

Referring to FIG. 13, in the case where both of the D2D-UEs which form a pair for D2D communication belong to the same servicing base station, and where the said base station is a FDD base station or a TDD base station, the type 2″ D2D subframe 510 is used when:

the immediately prior subframe is either a D2D subframe of the same connection (see 510.1) or a cellular TDD special subframe (510.2) if the base station is a TDD base station, and

the immediately following subframe is either a D2D subframe of the same connection with opposite transmission direction (see 510.3), or a D2D subframe of another connection, or a cellular UL subframe (510.4) if the base station is a TDD base station.

3. Type 3 D2D Subframe

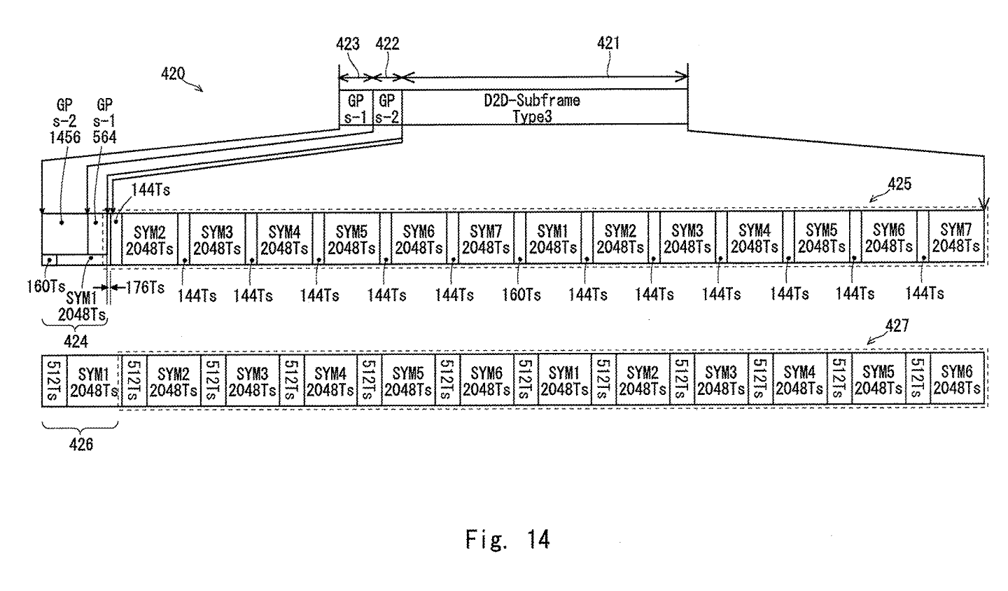

The type 3 D2D subframe 420 is illustrated in FIG. 14. This subframe 421 does not require a guard period at the subframe end but does require guard periods at the subframe start 423 for handling RX-TX switching. In the case of normal CP, the last 13 OFDM or SC-FDMA symbols 425 are used for transmitting/receiving D2D channel(s) and/or D2D signal(s). In the case of extended CP, the last 11 OFDM or SC-FDMA symbols 427 are used for transmitting/receiving D2D channel(s) and/or D2D signal(s). For both the normal CP and extended CP cases, the first OFDM or SC-FDMA symbol is DTX.

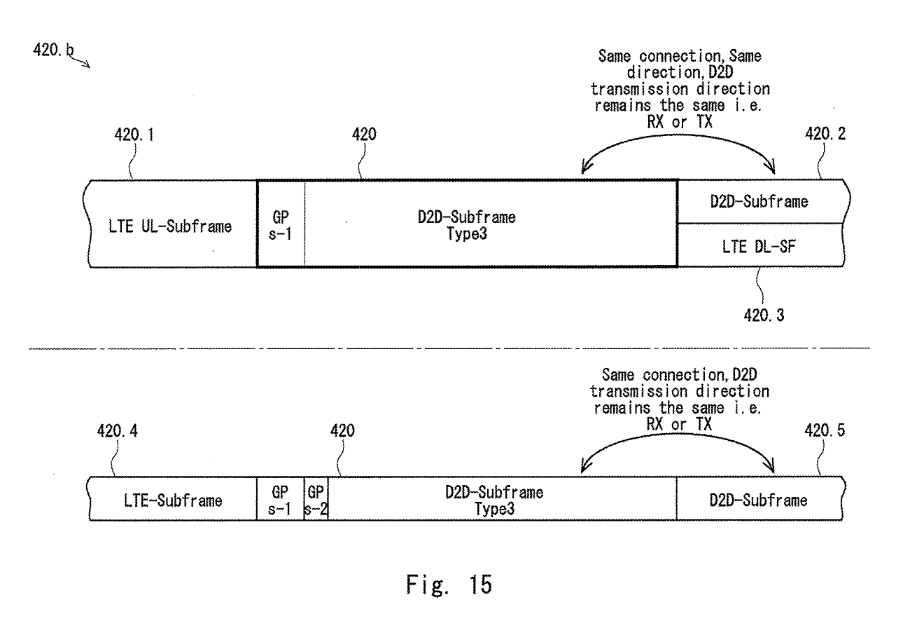

Referring to FIG. 15, in the case where both of the D2D-UEs which form a pair for D2D communication belong to the same servicing base station, and where the said base station is a FDD base station or a TDD base station, the type 3 D2D subframe 420 is used when:

the immediately prior subframe is a cellular UL subframe (see 420.1), and

the immediately following subframe is either a D2D subframe of the same connection with the same transmission direction (420.2) or a cellular DL subframe (420.3) if the base station is a TDD base station.

4. Type 4″ D2D Subframe

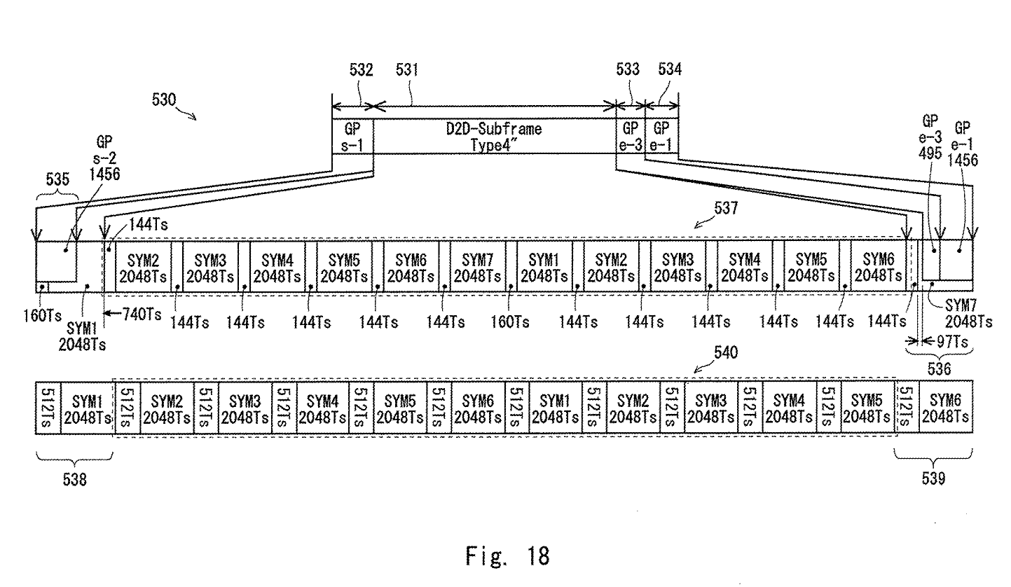

The type 4″ D2D subframe 530 is illustrated in FIG. 18. This subframe requires a guard period 532 at the subframe start for handling TX-RX switching time and it also requires guard periods 533 and 534 at the subframe end for handling subframe collision and RX-TX switching. In the case of normal CP, the 2nd to 13th OFDM or SC-FDMA symbols 537 are used for transmitting/receiving D2D channel(s) and/or D2D signal(s). In the case of extended CP, the 2nd to 11th OFDM or SC-FDMA symbols 540 are used for transmitting/receiving D2D channel(s) and/or D2D signal(s). For both the normal CP and extended CP cases, the first and last OFDM or SC-FDMA symbol in a D2D subframe are DTX.

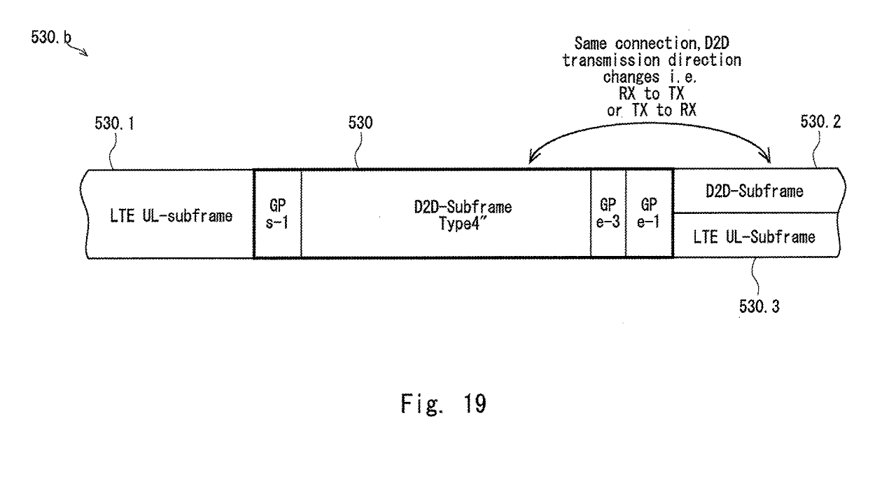

Referring to FIG. 19, in the case where both of the D2D-UEs which form a pair for D2D communication belong to the same servicing base station, and where the said base station is a FDD base station or a TDD base station, the type 4″ D2D subframe 530 is used when:

the immediately prior subframe is a cellular UL subframe (see 530.1), and

the immediately following subframe is either a D2D subframe of the same connection with opposite transmission direction (see 530.2), or a D2D subframe of another connection, or a cellular UL subframe 530.3.

In transmitting one or more of the above D2D subframe types, a D2D-UE may optionally retard a subframe transmission, possibly for half of its network configured TA in comparison with the corresponding network configured cellular UL subframe in order to help bring D2D-UE transmit and D2D-UE receive into approximate D2D subframe reference timing alignment. This may help to enhance D2D subframe boundary detection.

By way of further explanation, as can be seen from the timing analysis, TA can be considered as 2× propagation delay (i.e. until the propagation delay), so halving the configured TA for both D2D transmit and D2D receive may lead to D2D transmit and D2D receive having, approximately at least, a common reference timing i.e. aligned with base station timing.

A second aspect of the present invention relates to a method and a D2D subframe structure for sending and receiving D2D channel(s) and/or D2D signal(s) in such a way as to avoid or at least help manage intra-UE collision and/or inter-UE interference, and a allow paired D2D-UEs to negotiate dynamic selection of any UL subframe in a radio frame for D2D communication while maintaining their cellular UL transmission, in a system where paired D2D communicating UEs each belong to a different servicing base station. (Note: this is different to the first aspect of the invention above which is concerned with the situation where paired D2D communicating UEs belong to the same servicing base station.) In the context of the second aspect of the invention, two respective base stations may operate with both using FDD (i.e. FDD-FDD), or with both using TDD (i.e. TDD-TDD), or with one using FDD and the other using TDD (i.e. FDD-TDD/TDD-FDD).

When one D2D-UE is discovering other D2D-UE(s), or is being discovered by another D2D-UE, for the purposes of forming a pair for D2D communication, one D2D-UE may only know whether or not the other D2D-UE shares the same servicing base station. In other words, all that one D2D-UE will know about the other is whether it shares the same base station or belongs to a different base station. In the case where the other D2D-UE belongs to a different base station, the said UE may not know further information such as, for example, if the other servicing base station is FDD or TDD, the UL-DL configuration if the other base station happens to be TDD, if the other servicing base station uses flexible TDD, etc.

A FDD or TDD D2D-UE may be configured by its own servicing base station as to the cellular UL resources on which it is allowed to transmit and receive D2D channel(s) and/or D2D signal(s). Set out below are timing analyses for worst case scenarios for different system combinations to identify requirements for D2D communication subframe types and associated applications, bearing in mind that a D2D-UE may not know the system configuration of the other D2D-UE to which it is (or may be) paired.

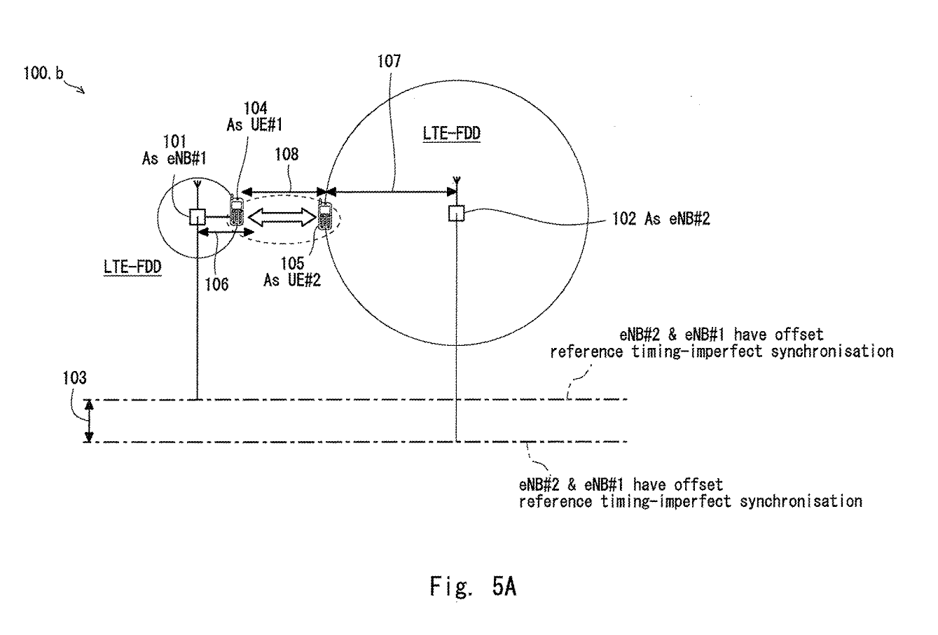

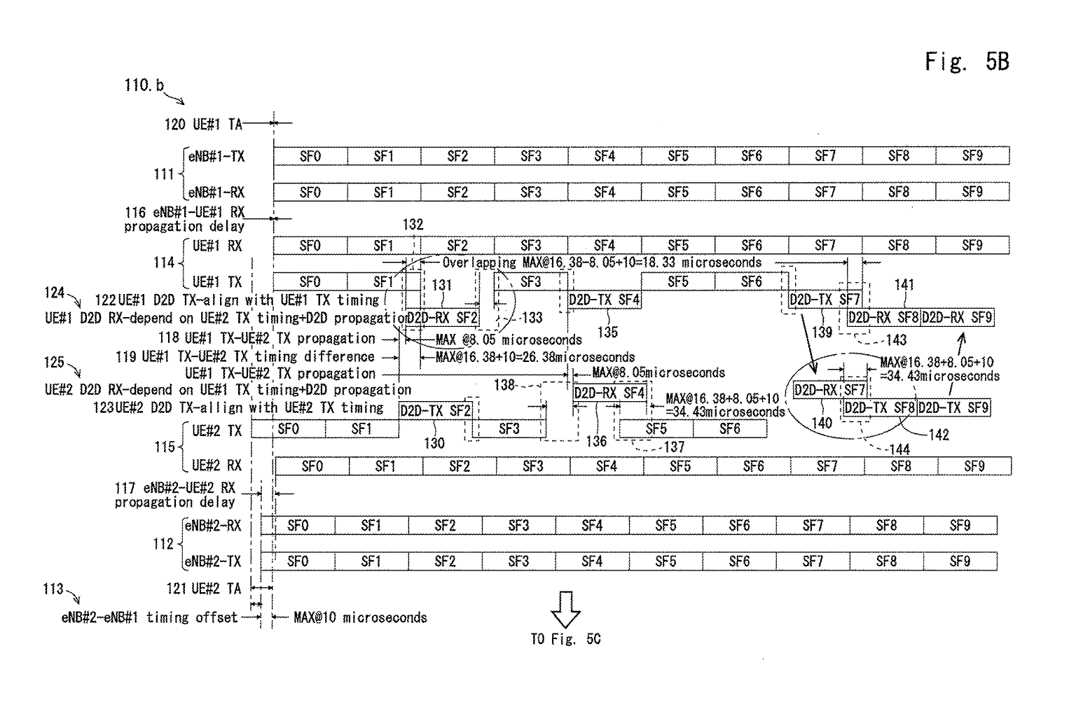

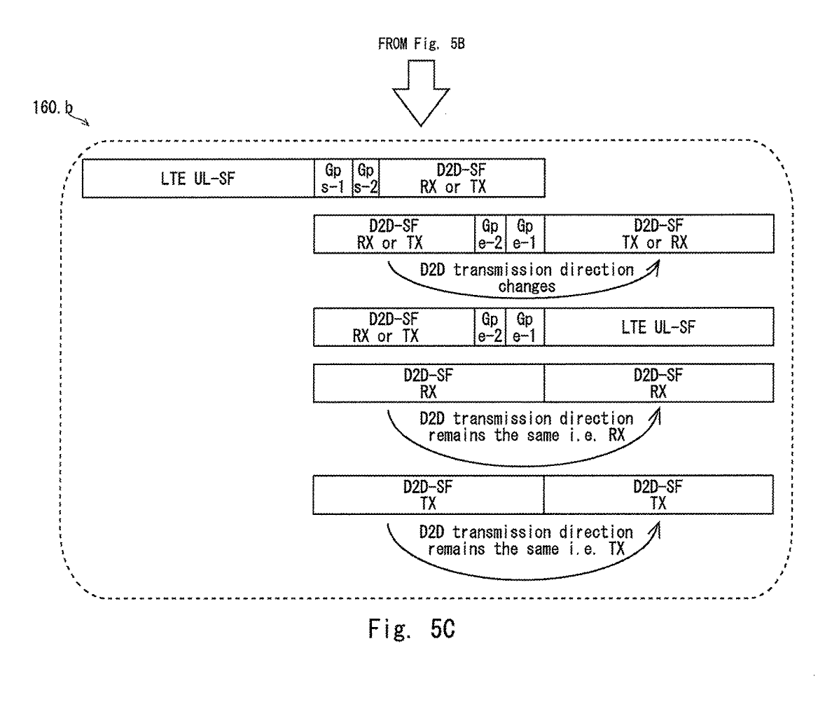

FIGS. 5A,5B and 5C illustrates, among other things, a system 100.b which represents a worst case scenario wherein maximum D2D subframe collision and/or interference occurs in a FDD-FDD system. In the said system, D2D-UEs 104 and 105, which are paired for D2D communication, each belong to a different FDD servicing base station. More specifically, D2D-UE (UE#1) 104 belongs to the first base station (eNB#1) 101, and D2D-UE (UE#2) 105 belongs to the second base station (eNB#2) 102. D2D-UEs 104 and 105 are separated at a maximum allowed distance 108 (1.5 miles in practical implementations). FDD D2D-UE 104 is located at a position such that distance 106 between servicing first base station 101 and FDD D2D-UE 104 results in a minimum possible timing advance (TA) of 0, and FDD D2D-UE 105 (the other D2D-UE) is located at a position such that the distance 107 between second servicing base station 102 and FDD D2D-UE 105 results in a maximum possible timing advance (TA) of 32. Furthermore, the first base station 101 and the second base station 102 may have different timing references due to imperfect inter-base station timing synchronisation. Imperfect timing synchronisation may result in a timing reference offset, which may be up to 10 μsec in practical implementations.

In the timing diagram 110.b in FIGS. 5A,5B and 5C, which corresponds to the scenario described immediately above, the first base station's TX-RX timing 111 servicing FDD D2D-UE 104 has a timing retard 113 (the timing retard 113 being 10 μsec in this example) compared with the second base station's TX-RX timing 112 servicing FDD D2D-UE 105. The distance 106 results in a (nil) propagation delay 116 for transmitting a cellular DL subframe from the first servicing base station 101 to FDD D2D-UE 104. For a SC-FDMA symbol sent by all UE(s) under the first servicing base station and arriving at the first servicing base station 101 within a CP length, the first servicing base station 101 configures FDD D2D-UE 104 to have a (nil) TA 120 that results in cellular UL subframe timing 114. On the other hand, the distance 107 results in (a non-zero) propagation delay 117 for transmitting a cellular DL subframe from the second serving base station 102 to FDD D2D-UE 105. For a SC-FDMA symbol sent by all UE(s) under the second servicing base station and arriving at the second servicing base station 102 within a CP length, the second servicing base station 102 configures FDD D2D-UE 105 to have (a non-zero) TA 121 of 32, which results in cellular UL subframe timing 115.

This arrangement results in FDD D2D-UEs 104 and 105 having a maximum TX timing difference 119 (this timing difference is 26.38 μsec in this example). Furthermore, the maximum separation 108 (which is 1.5 miles in this example) between FDD D2D UE 104 and FDD D2D-UE 105 results in a propagation delay 118 (this propagation delay is 8.05 μsec in this example) for transmitting a D2D subframe from FDD D2D-UE 104 to FDD D2D-UE 105 or via versa. According to a current working assumption endorsed in the above 3GPP D2D SI, cellular UL subframe timing of each servicing base station is used as reference timing for sending D2D subframe (see 122 and 123), and this makes the D2D RX (124 and 125) timing at a receiving D2D-UE (104 and 105) depend on the timing of D2D TX from the transmitting D2D-UE (105 and 104).

The system and associated timing as described above provides a basis for discussing of the design of a new D2D subframe structure for transmitting and receiving D2D channel(s) and/or D2D signal(s) under an overlaid FDD-FDD cellular network.

Still referring to FIGS. 5A, 5B and 5C, and randomly selecting cellular UL subframes #2 and #4 for D2D communication, on cellular UL subframe #2 FDD D2D-UE 105 performs transmission of a D2D subframe 130 and FDD D2D-UE 104 should then perform reception 131 of that D2D subframe. On UL subframe #4, FDD D2D-UE 104 performs transmission of a D2D subframe 135 and D2D-UE 105 should then perform reception 136 of that D2D subframe. For the D2D transmission on cellular UL subframe #2, at the D2D subframe transmission site (i.e. at the location of D2D-UE 105) the start of the transmitted D2D subframe is perfectly aligned with the corresponding cellular UL subframe, whereas at the D2D subframe reception site for that subframe (i.e. at the location of D2D-UE 104) the received D2D subframe has a subframe start earlier than the start of the corresponding cellular UL subframe, as indicated by 132. This is due to the TX timing difference 119 (the timing difference is 26.38 μsec in this example), and it causes a collision region (the collision region is 18.33 μsec in this example) in which transmission of the last symbol(s) of the previous cellular UL subframe collide with reception of the first symbol(s) of the D2D subframe.

Furthermore, transmitting a D2D subframe immediately after transmitting an UL cellular subframe (e.g. 130 or 135 or 139) does not require a D2D-UE to adjust its transmitter. However, receiving a D2D subframe immediately after transmitting an UL cellular subframe (e.g. 131 or 136 or 140) does require a D2D-UE to switch from its transmitter to its receiver. Thus, it is proposed to provide guard periods (GP s-1 and GP s-2) at the beginning of a transmitted D2D subframe which immediately follows a cellular UL subframe to account for TX-RX switching time and subframe colliding at the D2D receiving site.

At a D2D subframe transmission site, the end of the transmitted D2D subframe is perfectly aligned with the corresponding cellular UL subframe, whereas at the D2D subframe reception site for the said subframe, the end of the received D2D subframe collides or overlaps (see region 137, which is 34.43 μsec in this example) with the cellular UL subframe transmitted immediately thereafter. Transmitting a cellular UL subframe immediately after transmitting a D2D subframe (e.g. 130 or 135) does not require a D2D-UE to adjust its transmitter. However, transmitting an UL cellular subframe immediately after receiving a D2D subframe (e.g. 131 or 136) does require a D2D-UE to switch from its receiver to its transmitter. Thus, it is proposed to provide two guard periods (GP e-2 and GP e-1) at the end of a transmitted D2D subframe which has an immediately following cellular UL subframe to account for collision and RX-TX switching time at the corresponding D2D receiving site.

Multiple consecutive UL cellular subframes may be allocated for D2D communication, such as for example subframes #7, 8 and 9 illustrated in the timing diagram 110.b. Any two consecutive subframes for D2D communication which have the same direction, such as for example D2D-TX 142 or D2D-RX 141, will not require a guard period to account for switching and/or collision handling. However, any two consecutive subframes for D2D communication which have different directions, such as for example D2D-TX to D2D-RX 139 or D2D-RX to D2D-TX 140, will require guard period to account for RX-TX switching and collision handling. In the worst case scenario in the depicted example, guard period for collision handling may take up to 34.43 μsec. Thus, it is proposed to provide two guard periods (GP e-2 and GP e-1) at the end of a transmitted D2D subframe, where the immediately following subframe is a D2D subframe in the opposite direction, to account for collision and RX-TX switching time at the corresponding D2D receiving site.

The proposed guard periods mentioned above for a D2D subframe structure for a FDD-FDD system are graphically represented in diagram 160.b in FIGS. 5A,5B and 5C.

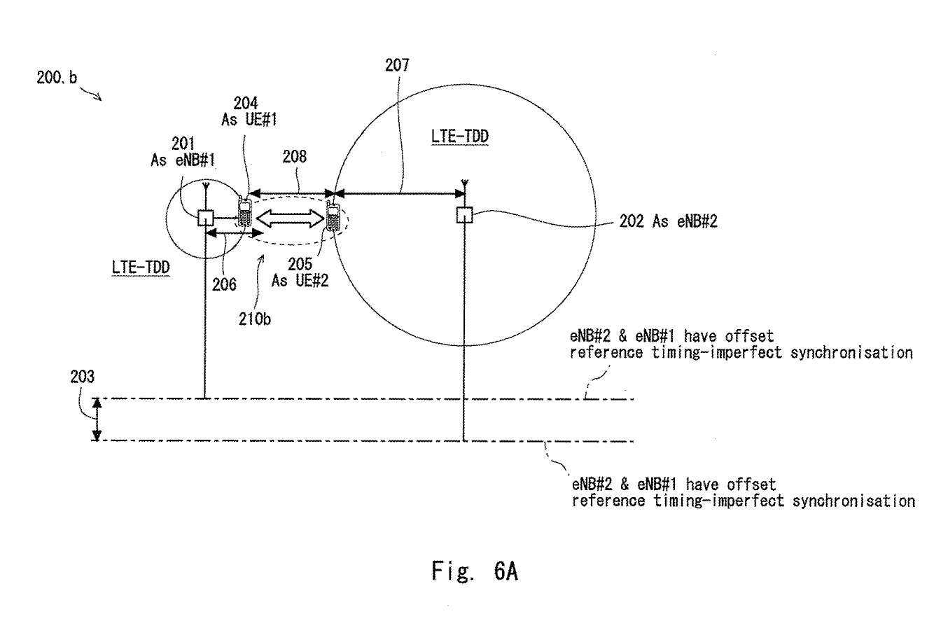

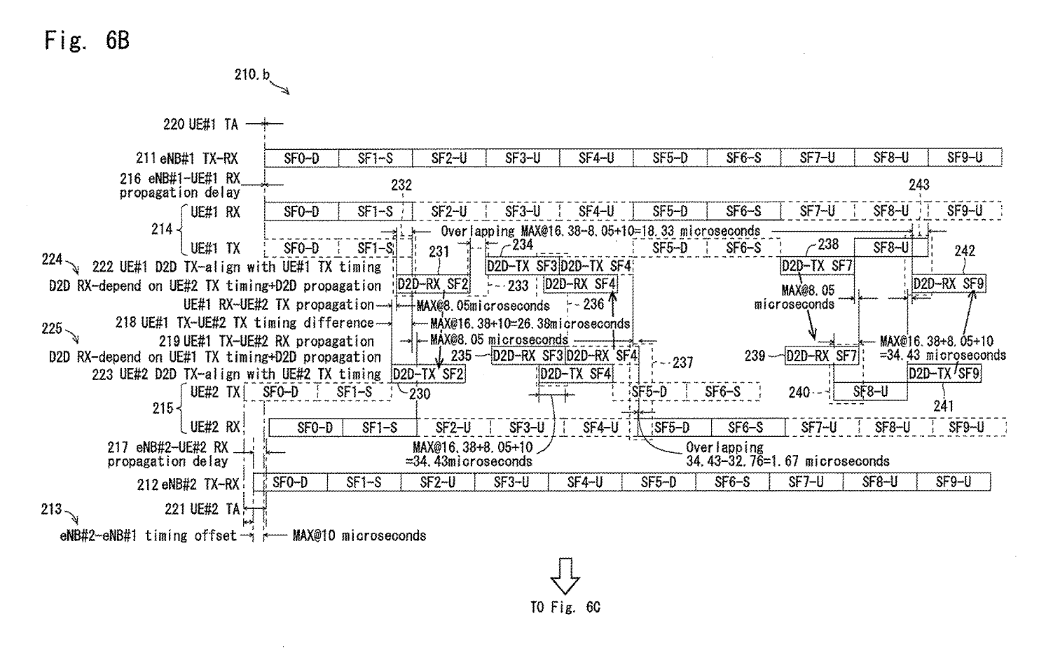

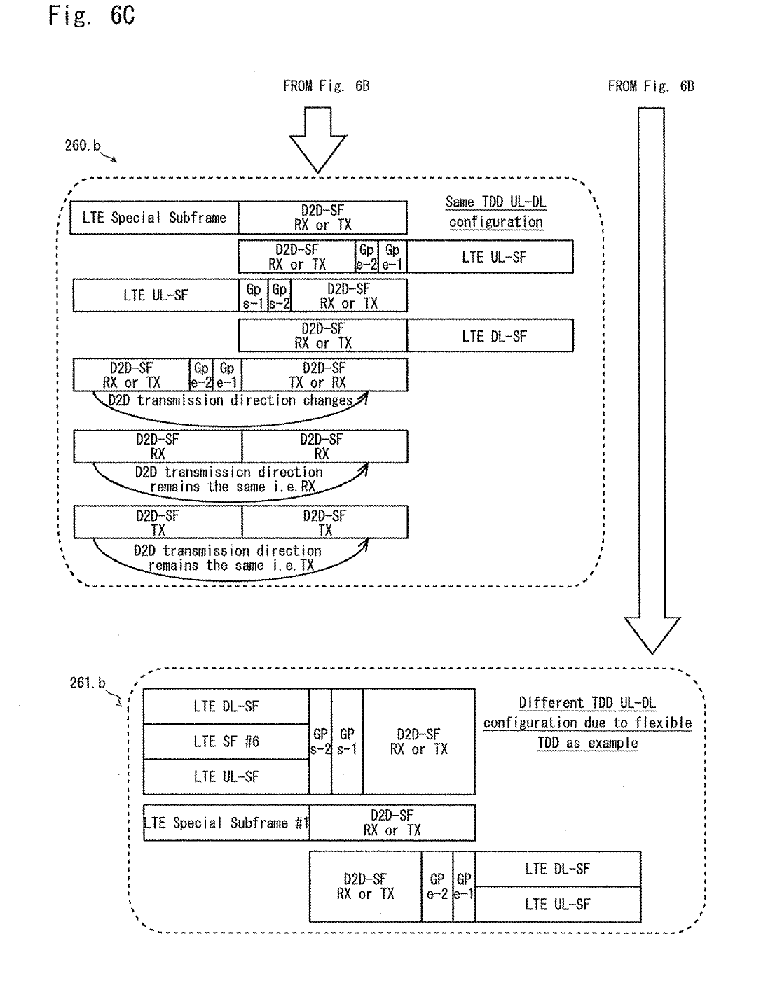

Turning now to FIGS. 6A, 6B and 6C, this Figure illustrates, among other things, a system 200.b which represents a worst case scenario wherein maximum D2D subframe collision and/or interference occurs in a TDD-TDD system. In the said system, D2D-UEs 204 and 205, which are paired for D2D communication, each belong to a different TDD servicing base station. More specifically, D2D-UE (UE#1) 204 belongs to the first base station (eNB#1) 201, and D2D-UE (UE#2) 205 belongs to the second base station (eNB#2) 202. D2D-UEs 104 and 105 are separated at a maximum allowed distance 208 (1.5 miles in practical implementations).

D2D-UE 204 is located at position such that the distance 206 between the first servicing base station 201 and TDD D2D-UE 204 results a minimum possible timing advance (TA) of 0, and TDD D2D-UE 205 is located at position such that the distance 207 between second servicing base station 202 and TDD D2D-UE 205 results in a maximum possible timing advance (TA) of 32. Furthermore, the first servicing base station 201 and the second servicing base station 202 may have different timing references due to imperfect inter-base station timing synchronisation. Imperfect timing synchronisation may result in a timing reference offset of up to 10 μsec.

In the timing diagram 210.b, a similar approach as was applied in the case of the FDD-FDD system above is used as a basis for discussing the design of a new D2D subframe structure for transmitting and receiving D2D channel(s) and/or D2D signal(s) under an overlaid TDD-TDD cellular network.

Referring to FIGS. 6A, 6B and 6C, and selecting cellular UL subframes #2 and/or #7 (both of which are immediately after a cellular TDD special subframe) for D2D communication, on cellular UL subframe #2 TDD D2D-UE 205 performs transmission of a D2D subframe 230 and TDD D2D-UE 204 should then perform reception 231 of that D2D subframe. On cellular UL subframe #7, TDD D2D-UE 204 performs transmission of a D2D subframe 238 and D2D-UE 205 should then perform reception 239 of that D2D subframe. At a D2D subframe transmission site, the start of a transmitted D2D subframe is always perfectly aligned with the start of the corresponding cellular UL subframe, but in the worst case scenario at the D2D subframe reception site for the said subframe, due to the D2D-UE's TX timing difference 218, the received D2D subframe has a subframe start earlier than that of the corresponding cellular UL subframe, as indicated by 232. Transmitting a D2D subframe immediately after receiving a cellular TDD special subframe (see 230 or 238) does not require a TDD D2D-UE to adjust its transmitter as TDD special subframes are designed to accommodate RX-TX switching. Receiving a D2D subframe immediately after receiving a cellular TDD special subframe (see 231 or 239) results in subframe collision or overlap (of a maximum of 18.33 μsec in practical implementations) between the cellular TDD special subframe end and the D2D RX subframe start. Technically, the UpPTS region designed for use in cellular TDD subframes is sufficient for dealing with this overlapping region. Thus, it is proposed that NO guard period is required at the beginning of a transmitted D2D subframe which immediately follows a certain cellular special subframe (such as subframe #1) to account for TX-RX switching time at the D2D transmitting site or to account for subframe collision at the D2D receiving site.

As mentioned previously, a D2D-UE belonging to (say) the first servicing base station may not know detailed information such as the UL-DL configuration of the second servicing base station, or if the second servicing base station is flexible TDD or not. Given that one of several different UL-DL configurations may be configured, the subframe #6 may happen to be a cellular DL subframe on the first serving base station and a special subframe on the other base station. Receiving a D2D subframe immediately after receiving a cellular TDD DL subframe may result in a collision or overlap (of a maximum of 18.33 μsec in practice) between the end of the cellular TDD DL subframe and the start of the D2D RX subframe. Transmitting a D2D subframe immediately after receiving a cellular TDD DL subframe may result in subframe collision or overlap (of a maximum of 32.76 μsec in practice) between the end of the cellular TDD DL subframe and the start of the D2D TX subframe. Thus, it is proposed to provide guard periods (GP s-1 and GP s-2) at the beginning of a transmitted D2D subframe which immediately follows an uncertain cellular special subframe (such as subframe #6) or a cellular UL subframe to account for RX-TX/RX-TX switching time at the D2D transmitting/receiving site and to account for subframe collision at the D2D transmitting and receiving site.

Similar to the FDD-FDD system discussed previously, transmitting an UL cellular subframe immediately after receiving a D2D subframe 239 results in a subframe collision and also requires a D2D-UE to switch from its receiver to its transmitter. Thus, it is proposed to provide two guard periods (GP e-2 and GP e-1) at the end of a transmitted D2D subframe which has an immediately following cellular UL subframe to account for collision and RX-TX switching time at the corresponding D2D receiving site.

Also similar to the FDD-FDD system above, multiple consecutive TDD UL cellular subframes may be allocated for D2D communication, such as subframes #2, 3 and 4 illustrated in the timing diagram 210.b. Any two consecutive subframes for D2D communication which have the same direction will not require guard period to account for switching and/or collision handling. However, any two consecutive subframes for D2D communication which have different directions, such as D2D-TX to D2D-RX 234 or D2D-RX to D2D-TX 235 will require guard periods to account for RX-TX switching and collision handling. In the worst case scenario in practice, guard period for collision handling may take up to 16.1 μsec 326. Thus, it is proposed to provide two guard periods (GP e-2 and GP e-1) at the end of a transmitted D2D subframe which has an immediately following D2D subframe with opposite direction to account for collision and RX-TX switching time at the corresponding D2D receiving site.

The proposed guard periods mentioned above for a D2D subframe structure for a TDD-TDD system are graphically represented in diagrams 260.b (for same UL-DL configuration) and 261.b (for different UL-DL configuration).

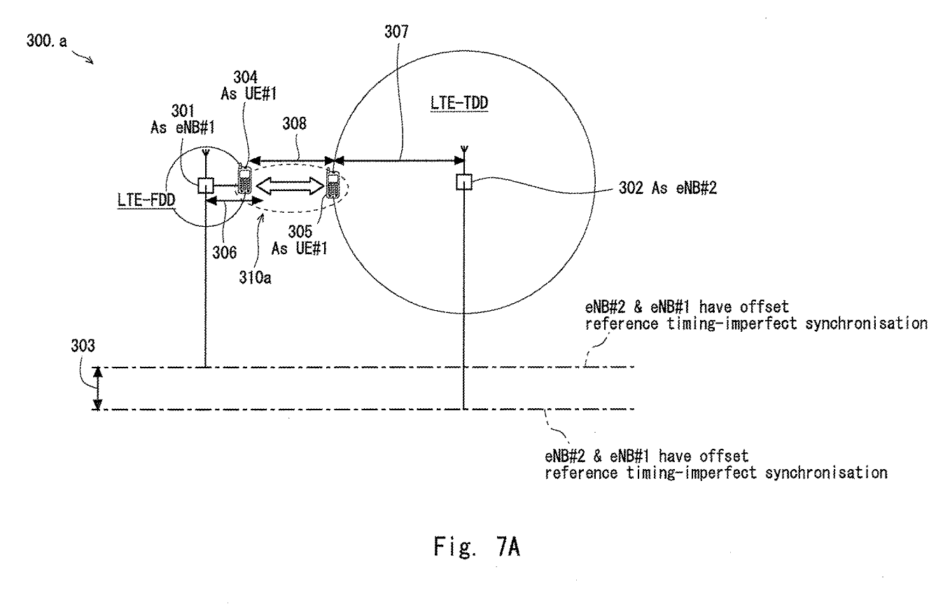

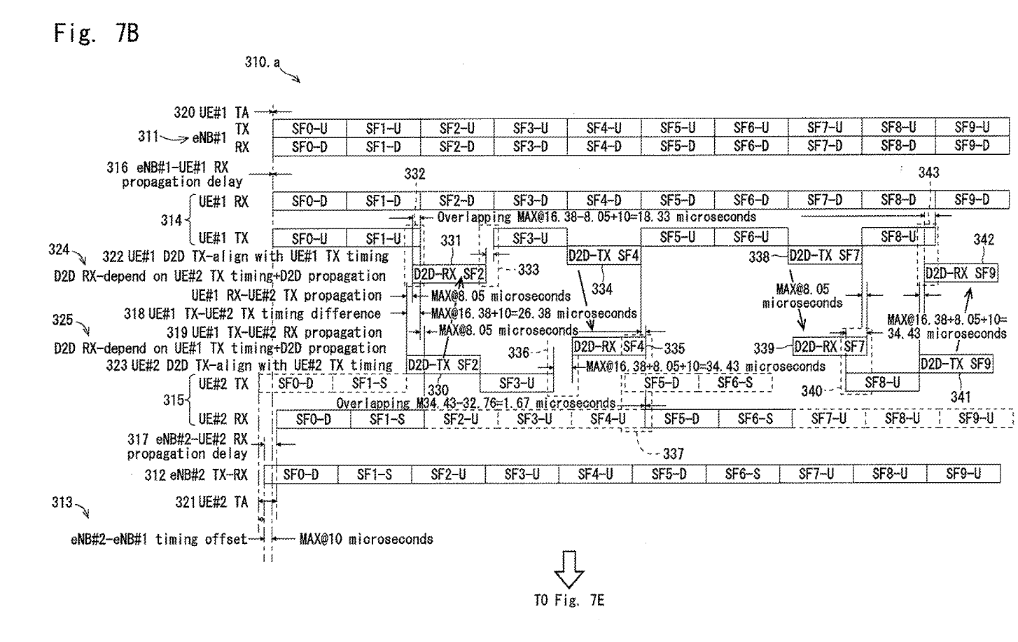

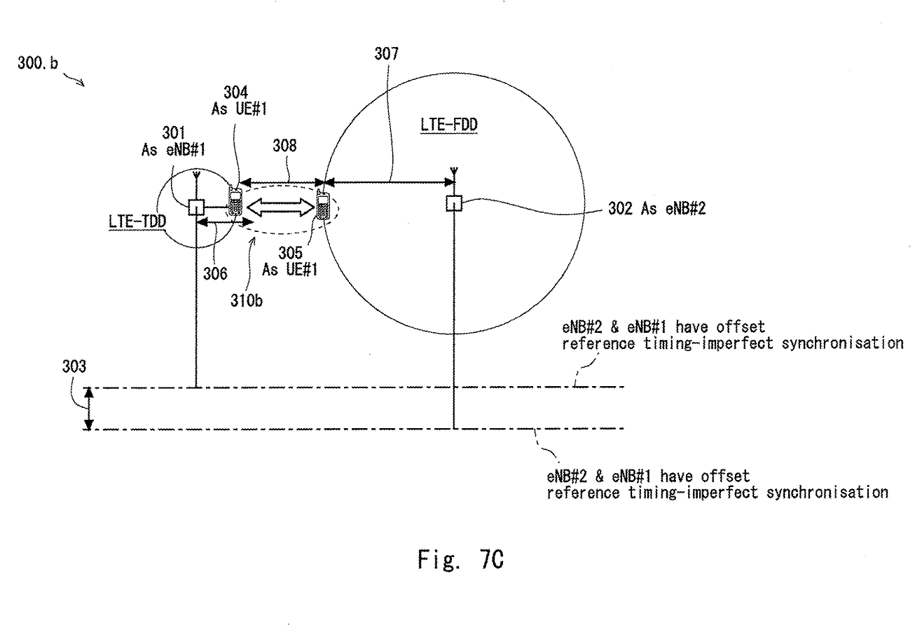

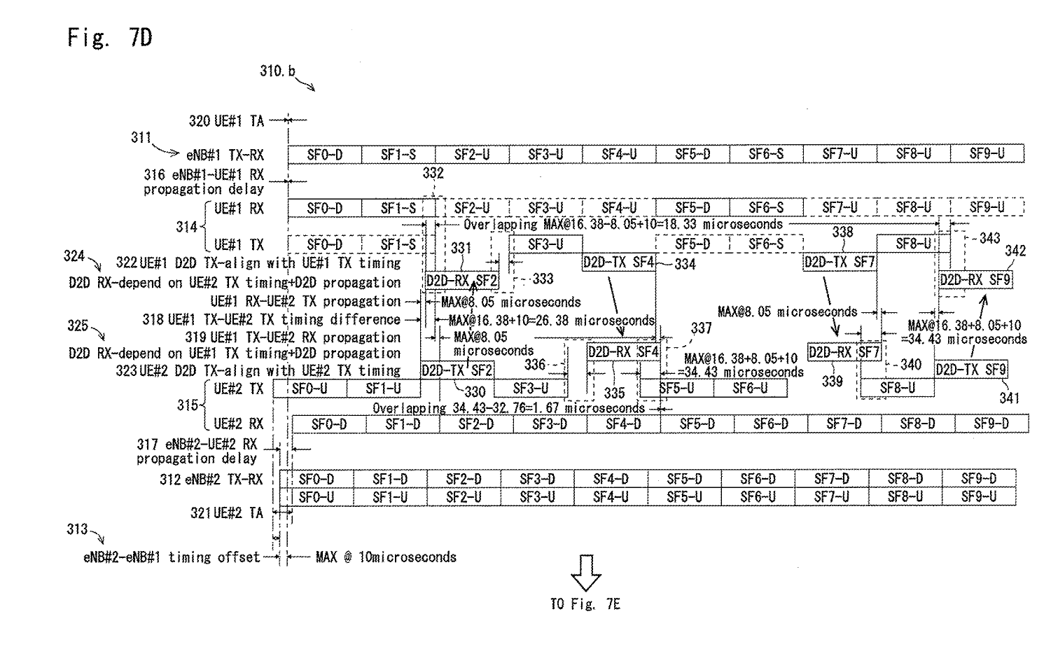

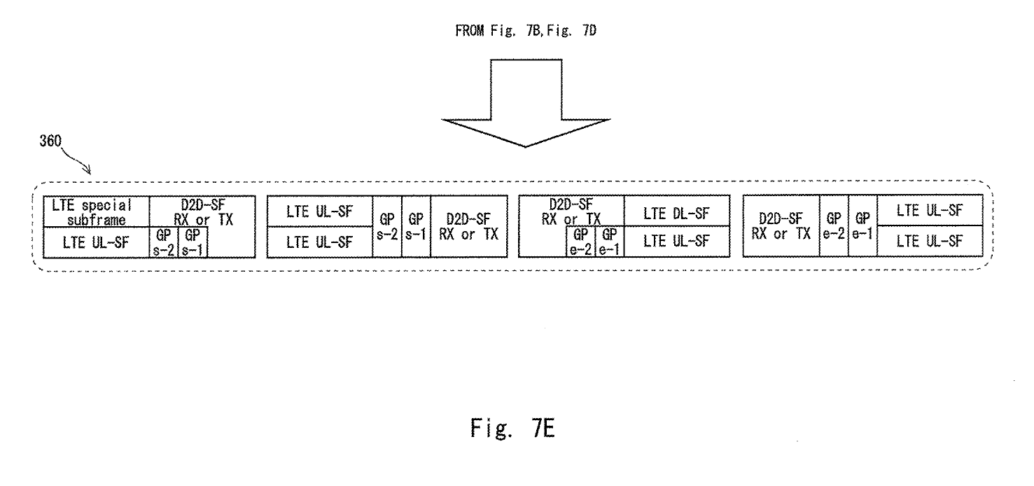

Turning now to FIGS. 7A, 7B, 7C, 7D and 7E, this Figure illustrates, among other things, systems 300.a and 300.b which represent worst case scenarios wherein maximum D2D subframe collision and/or interference occur in FDD-TDD/TDD-FDD systems. In both systems 300.a and 300.b, the D2D-UE (UE#1) 304 belongs to the first base station (eNB#1) 301, the D2D-UE (UE#2) 305 belongs to the second base station (eNB#2) 302, and D2D-UEs 304 and 305 are paired for D2D communication. However, in system 300.a the first base station (eNB#1) 301 is FDD (meaning that D2D-UE 304 is a FDD D2D-UE) and the second base station (eNB#2) 302 is TDD (meaning that D2D-UE 305 is a TDD D2D-UE), whereas in system 300.b the first base station (eNB#1) 301 is TDD (meaning that D2D-UE 304 is a TDD D2D-UE) and the second base station (eNB#2) 302 is FDD (meaning that D2D-UE 305 is a FDD D2D-UE). In both systems 300.a and 300.b, the D2D-UEs 304 and 305 are separated by a maximum allowed distance 308 (1.5 miles in practice).

In both systems 300.a and 300.b, D2D-UE 304 is located at a position such that the distance 306 between first servicing base station 301 and D2D-UE 304 results in a minimum possible timing advance (TA) of 0, and D2D-UE 305 is located at a position such that the distance 307 between second servicing base station 302 and D2D-UE 305 results in a maximum possible timing advance (TA) of 32. Furthermore, the first base station 301 and second base station 302 may have different timing references due to imperfect inter-base station timing synchronisation. Imperfect timing synchronisation may result in a timing reference offset (which may be up to 10 μsec in practice).

In timing diagrams 310.a and 310.b, a similar approach as was applied in the cases of the FDD-FDD and TDD-TDD systems above is used as a basis for discussing the design of a new D2D subframe structure for transmitting and receiving D2D channel(s) and/or D2D signal(s) under an overlaid FDD-TDD or TDD-FDD cellular network.

Referring to FIGS. 7A, 7B, 7C, 7D and 7E, cellular UL subframes #2 and/or #7 (which are immediately after cellular TDD special subframes in the second base station for system 300.a, and likewise in the first base station for system 300.b) are specifically selected for D2D communication. In both systems 300.a and 300.b, on cellular UL subframe #2, D2D-UE 305 performs transmission of a D2D subframe 330 and D2D-UE 304 should then perform reception 331 of that D2D subframe. On cellular UL subframe #7, D2D-UE 304 performs transmission of a D2D subframe 338 and D2D-UE 305 should then perform reception 339 of that D2D subframe. At a D2D subframe transmission site, the start of a transmitted D2D subframe is always perfectly aligned with the corresponding cellular UL subframe, but in the worst case scenario at the D2D subframe reception site for the said subframe, due to the D2D-UE's TX timing difference 318, a received D2D subframe has a subframe start which is earlier than that of the corresponding cellular subframe, and this causes a collision with the end of the immediately prior cellular subframe, as indicated by 332.

In timing diagram 300.a, transmitting a D2D subframe immediately after receiving a cellular TDD special subframe (e.g. 330) does not require TDD D2D-UE 305 to adjust its transmitter as TDD special subframes are designed to accommodate RX-TX switching. However, receiving a D2D subframe immediately after transmitting a cellular FDD UL subframe (331) results in a subframe collision or overlap (of maximum 18.33 μsec in practice) between the end of the cellular FDD UL subframe and the start of the D2D RX subframe. Furthermore, receiving a D2D subframe immediately after transmitting a cellular FDD UL subframe (331, 343) requires a FDD D2D-UE to switch from transmitting to receiving. Thus, it is proposed to provide two guard periods (GP s-1 and GP s-2) at the beginning of a transmitted D2D subframe which immediately follows a cellular subframe such as a TDD special subframe or a cellular UL subframe to account for RX-TX/RX-TX switching time at the D2D transmitting/receiving end and to account for subframe collision at the D2D receiving site.

Furthermore, transmitting an UL cellular subframe immediately after receiving a D2D subframe (e.g. 340) results in a subframe collision and also requires a D2D-UE to switch its receiver to transmitter. Thus, it is proposed to provide two guard periods (GP e-2 and GP e-1) at the end of a transmitted D2D subframe which has an immediately following cellular subframe such as a TDD DL subframe or a UL subframe to account for subframe collision and RX-TX switching time at the corresponding D2D receiving site.

Similar to the FDD-FDD and TDD-TDD systems above, multiple consecutive TDD UL cellular subframes may be allocated for D2D communication. Any two consecutive subframes for D2D communication which have the same direction will not require guard period to account for switching and/or collision handling. However, any two consecutive subframes for D2D communication which have different directions, i.e. D2D-TX to D2D-RX or D2D-RX to D2D-TX, will require guard periods to account for RX-TX switching and collision handling. In the worst case scenario in practice, guard period for collision handling may take up to 34.43 μsec. Thus, it is proposed to provide two guard periods (GP e-2 and GP e-1) at the end of a transmitted D2D subframe which has an immediately following D2D subframe with opposite direction to account for collision and RX-TX switching time at the corresponding D2D receiving site.

The proposed guard periods mentioned above for a D2D subframe structure for a FDD-TDD or TDD-FDD system are graphically represented in diagram 360 in FIGS. 7A,7B,7C,7D and 7E.

It is to be recalled that the above timing analyses and proposals for transmitting and receiving D2D channel(s) and/or D2D signal(s), as explained with reference to FIGS. 5A, 5B, 5C, 6A, 6B, 6C, 7A, 7B, 7C, 7D and 7E, relate to cases where each D2D-UE in a pair formed for D2D communication belongs to a different servicing base station, and each said base station may be a FDD or TDD base station (thus giving FDD-FDD, TDD-TDD and FDD-TDD/TDD-FDD as possible system scenarios). Five types of D2D subframes are proposed for D2D communication where two D2D UEs which are paired for D2D communication belong to different cellular servicing base station. These are:

1. Type 1 D2D Subframe

The type 1 D2D subframe 400 is illustrated in FIG. 8. This subframe does not require a guard period either at the beginning or at the end of a D2D subframe 401. In the case of normal CP, all 14 OFDM or SC-FDMA symbols 402 are used for transmitting/receiving D2D channel(s) and/or D2D signal(s). In the case of extended CP, all 12 OFDM or SC-FDMA symbols 403 are used for transmitting/receiving D2D channel(s) and/or D2D signal(s).

Referring to FIG. 9, in the case where both of the D2D-UEs which form a pair for D2D communication belong to different servicing base stations, the type 1 D2D subframe 400 is used when:

the immediately prior subframe is a D2D subframe (400.5), and

the immediately following subframe is a D2D subframe of the same transmission direction (400.6).

2. Type 2 D2D Subframe

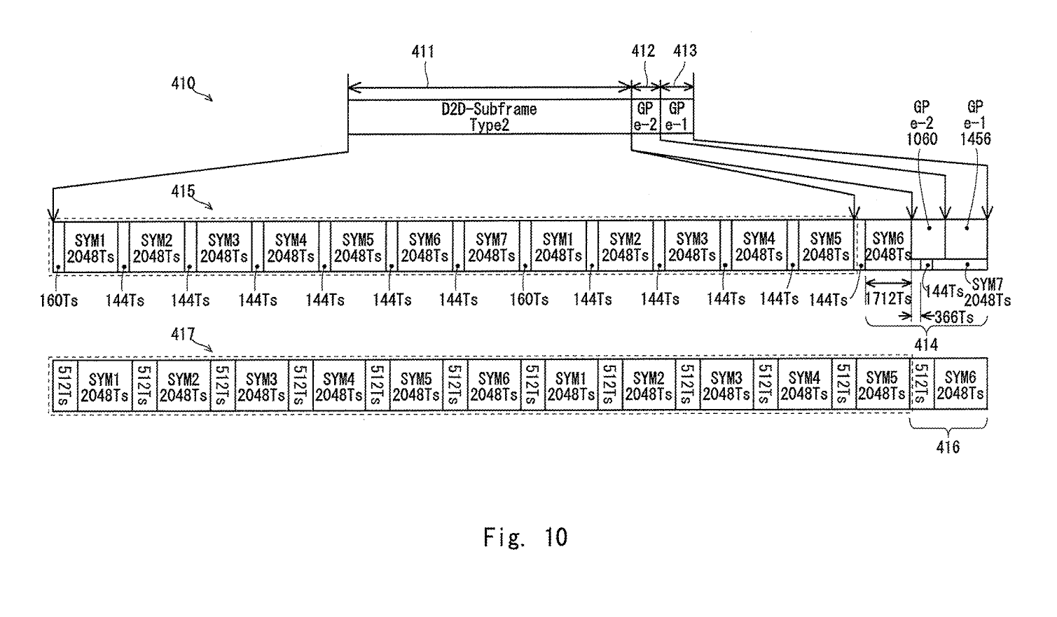

The type 2 D2D subframe 410 is illustrated in FIG. 10. This subframe does not require guard period at the subframe start 411 but does require guard periods at the D2D subframe end 412 and 413 for handling subframe collision and RX-TX switching respectively. In the case of normal CP, the first 12 OFDM or SC-FDMA symbols 415 are used for transmitting/receiving D2D channel(s) and/or D2D signal(s) and the last two symbols are DTX. In the case of extended CP, the first 11 OFDM or SC-FDMA symbols 417 are used for transmitting/receiving D2D channel(s) and/or D2D signal(s) and the last symbol is DTX.

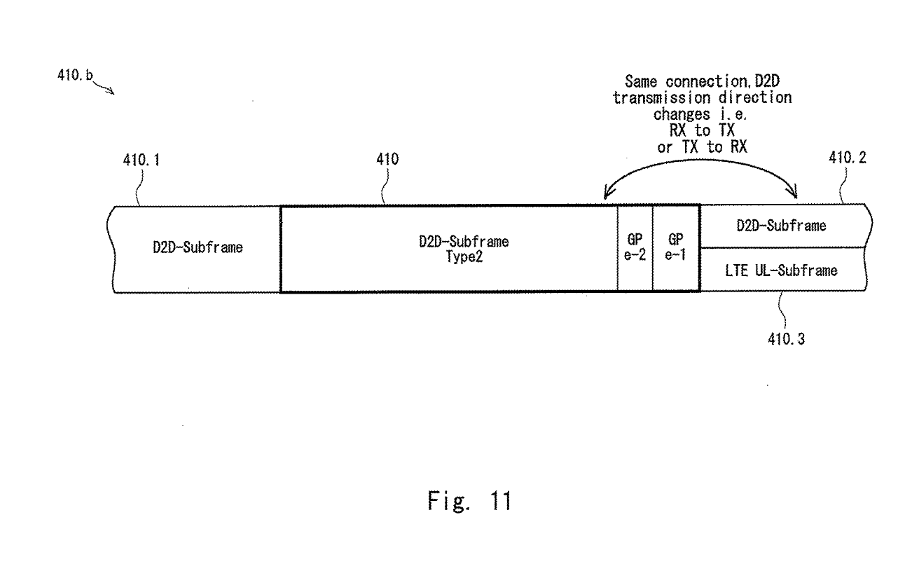

Referring to FIG. 11, in the case where D2D UEs which form a pair for D2D communication belong to different cellular servicing base stations (i.e. FDD-FDD, TDD-TDD or TDD-FDD/FDD-TDD), the type 2 D2D subframe 410 is used when:

the immediately prior subframe is a D2D subframe 410.1, and

the immediately following subframe is either a D2D subframe of the same connection but with the opposite transmission direction 410.2, or a D2D subframe of another connection, or a cellular subframe 410.3 including a cellular UL subframe or a cellular DL subframe.

3. Type 3 D2D Subframe

The type 3 D2D subframe 420 is illustrated in FIG. 14. This subframe does not require guard period at the subframe end 421 but it does require guard periods at the subframe start 422 and 423 for handling subframe collision and RX-TX switching. In the case of normal CP, the last 13 OFDM or SC-FDMA symbols 425 are used for transmitting/receiving D2D channel(s) and/or D2D signal(s). In the case of extended CP, the last 11 OFDM or SC-FDMA symbols 427 are used for transmitting/receiving D2D channel(s) and/or D2D signal(s). For both normal and extended CP, the first symbol is DTX.

Referring to FIG. 15, in the case where D2D UEs which form a pair for D2D communication belong to different cellular servicing base stations (i.e. FDD-FDD, TDD-TDD or TDD-FDD/FDD-TDD), the type 3 D2D subframe 420 is used when:

the immediately prior subframe is a cellular subframe 420.4, including a cellular FDD subframe or cellular TDD special subframe, and

the immediately following subframe is a D2D subframe of the same connection with the same TX/RX direction (420.5).

4. Type 4 D2D Subframe

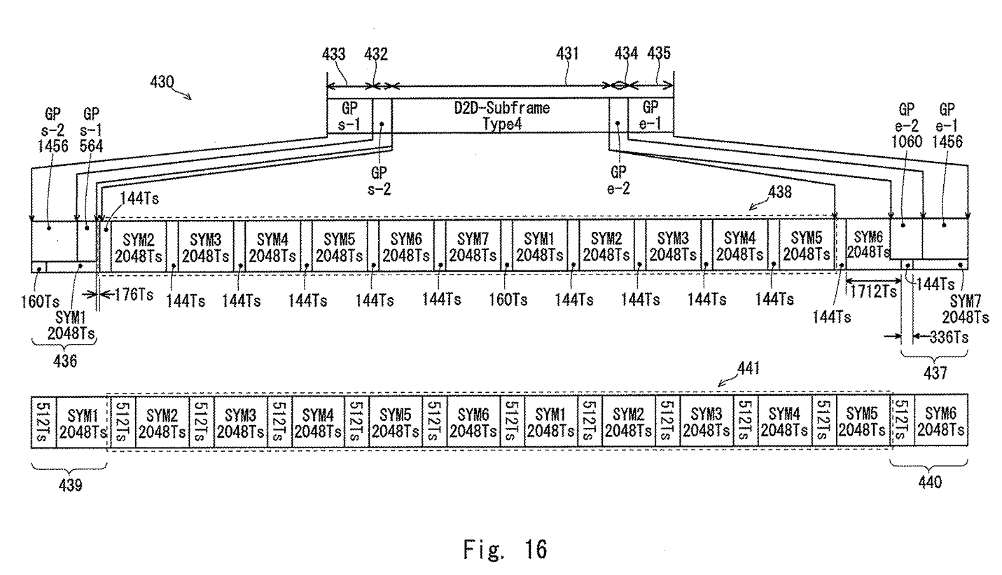

The type 4 D2D subframe 430 is illustrated in FIG. 16. This subframe requires guard periods at the subframe start 432 and 433 for handling subframe collision and TX-RX switching time, and it also requires guard periods at the subframe end 434 and 435 for handling subframe collision and RX-TX switching. In the case of normal CP, the first OFDM or SC-FDMA symbol is DTX, the 2nd to 12th OFDM or SC-FDMA symbols 438 are used for transmitting/receiving D2D channel(s) and/or D2D signal(s), and the last two OFDM or SC-FDMA symbols are DTX. In the case of extended CP, the first OFDM or SC-FDMA symbol is DTX, the 2nd to 11th OFDM or SC-FDMA symbols 441 are used for transmitting/receiving D2D channel(s) and/or D2D signal(s), and the last OFDM or SC-FDMA symbol is DTX.

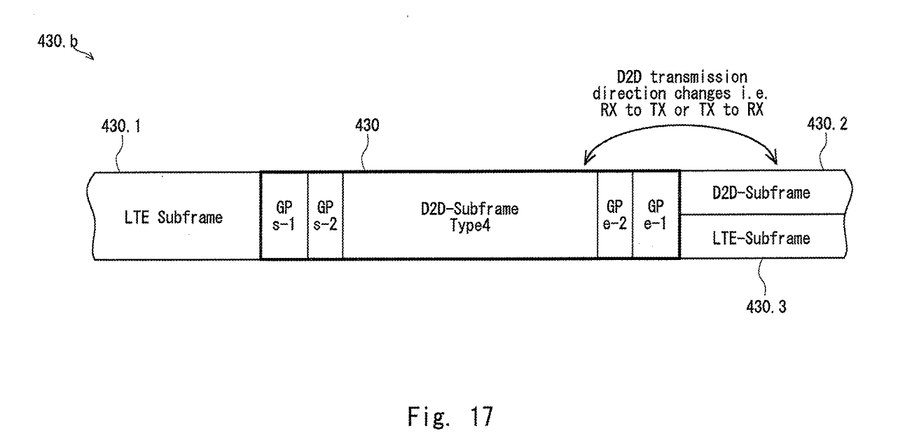

Referring to FIG. 17, in the case where D2D UEs which form a pair for D2D communication belong to different cellular servicing base stations (i.e. FDD-FDD, TDD-TDD or TDD-FDD/FDD-TDD), the type 4 D2D subframe 430 is used when:

the immediately prior subframe is a cellular subframe 430.1, and

the immediately following subframe is a D2D subframe of the same connection with opposite TX/RX direction 430.2, or a D2D subframe of another connection, or a cellular subframe 430.3 including a cellular UL or DL subframe.

5. Type 5 D2D Subframe

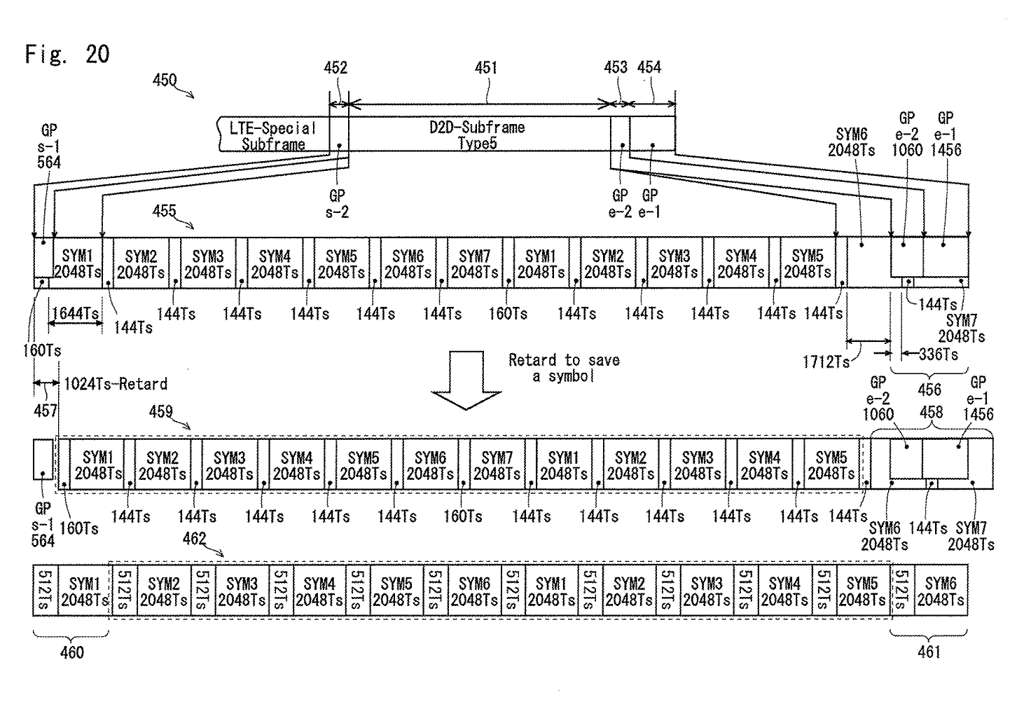

The type 5 D2D subframe 450 is illustrated in FIG. 20. This subframe requires a guard period at the subframe start 452 for handling subframe collision, and it also requires guard periods at the subframe end 453 and 454 for handling subframe collision and RX-TX switching. In the case of normal CP, the first 12 OFDM or SC-FDMA symbols 459 are used for transmitting/receiving D2D channel(s) and/or D2D signal(s) and the last two OFDM or SC-FDMA symbols are DTX. Additionally, transmitting a type 5 subframe with normal CP requires a retardation 457 (preferably of 1024.Ts) to save one OFDM/SC-FDMA symbol. In the case of extended CP, the first OFDM/SC-FDMA symbol is DTX, the 2nd to 11th OFDM or SC-FDMA symbols 462 are used for transmitting/receiving D2D channel(s) and/or D2D signal(s), and the last OFDM/SC-FDMA symbol is DTX.

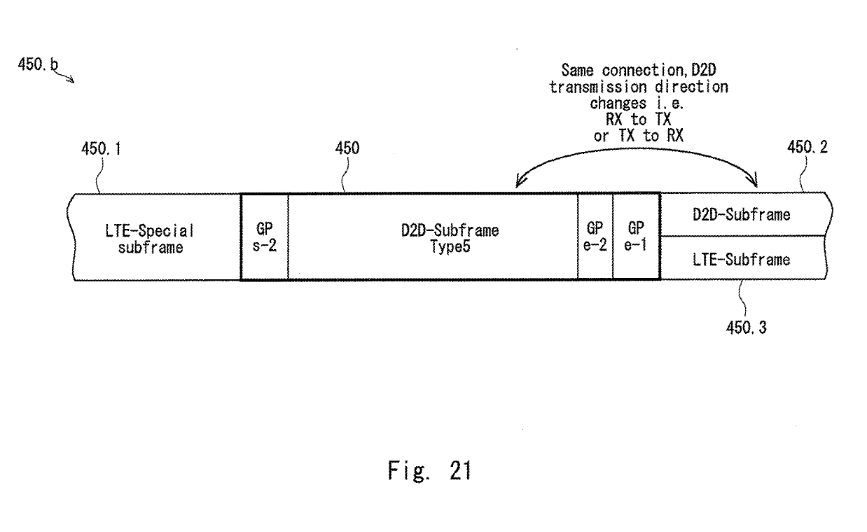

Referring to FIG. 21, in the case where D2D UEs which form a pair for D2D communication belong to different cellular servicing TDD base stations (i.e. TDD-TDD), the type 5 D2D subframe 450 is used when:

the immediately prior subframe is a certain cellular special subframe 450.1, such as subframe #1, and

the immediately following subframe is a D2D subframe of the same connection but with opposite transmission direction (450.2), or a D2D subframe of another connection, or a cellular subframe 450.3.

In transmitting one or more of the above D2D subframe types, a D2D-UE may optionally retard a subframe transmission, possibly for half of its network configured TA in comparison with the corresponding network configured cellular UL subframe in order to help bring D2D-UE transmit and D2D-UE receive into approximate D2D subframe reference timing alignment. This may help to enhance D2D subframe boundary detection.

The present invention may provide a number of advantages. For example:

The present invention may help to resolve or manage intra-UE collision and inter-UE interference due to, for instance, timing misalignment, and may hence help to allow cellular communication and D2D communication sharing the same resource on a subframe basis.

The various D2D subframe types discussed above are carefully designed, each with specific guard periods (GPs) and length, in order to handle intra-UE collision and/or inter-UE interference, and hence help to minimise redundant GPs when a single D2D subframe type is used.

The various D2D subframe types are designed to be dynamically selected (or selectable) by a transmitting D2D-UE for transmitting D2D channel(s) and/or D2D signal(s) simply and in a manner which is implicitly understood by receiving D2D-UE(s) without the need for signalling to inform the receiving D2D-UE(s) of the particular D2D subframe type used.

The present invention should have little or no impact on the legacy LTE specification.

Also, in comparison with conventional IEEE P2P technology (which might be considered, in general terms, to represent a current competing state of the art technology supporting direct communication), the present invention may provide a number of advantages:

It allows cellular communication and D2D communication, sharing the same cellular UL resource, on a subframe basis, thereby assisting dual connectivity (i.e. cellular connectivity plus direct connectivity, if this is required or desirable);

IEEE P2P is designed to operate on different resources within unlicensed spectrum, whereas D2D communication as presently proposed is designed to operate on licensed spectrum, thus supporting general direct communication without affecting or jeopardizing public safety communication.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

(Supplementary Note 1)

A signalling method for use in an advanced wireless communications system, wherein the system includes:

at least one servicing base station; and
at least a first and a second direct (D2D) communication capable user equipment (D2D-UE), wherein each D2D-UE is in cellular communication with a servicing base station, and the first D2D-UE and second D2D-UE, at least, are paired or grouped for D2D communication with one another,
the method comprising, on a given subframe,
performing D2D communication by transmitting D2D channel(s) and/or D2D signal(s) between one D2D-UE and another using a D2D subframe type which allows RX-TX switching time and/or prevents subframe collision at the receiving D2D-UE.

(Supplementary Note 2)

The signalling method as noted in Supplementary note 1, wherein there is a plurality of different D2D subframe types which can allow RX-TX switching time and/or prevent subframe collision at the receiving D2D-UE, depending on the subframe type of a preceding and/or subsequent subframe, the method further comprising:

selecting an appropriate D2D subframe type from among the plurality of different D2D subframe types for use on a given subframe; and
transmitting D2D channel(s) and/or D2D signal(s) from one D2D-UE to another on the given subframe using the selected D2D subframe type.

(Supplementary Note 3)

The signalling method as noted in Supplementary note 2, wherein the method for selecting an appropriate D2D subframe type from among the said plurality of different D2D subframe types does not require signalling between paired or grouped D2D-UEs to indicate the D2D subframe type selected for use in a given subframe.

(Supplementary Note 4)

The signalling method as noted in Supplementary note 2 or 3, wherein the first D2D-UE and second D2D-UE, at least, are in cellular communication with the same servicing base station.

(Supplementary Note 5)

The signalling method as noted in Supplementary note 4, wherein the plurality of different D2D subframe types includes a first D2D subframe type which is selected for use in transmitting D2D channel(s) and/or D2D signal(s) on a given subframe when:
the immediately preceding subframe is either:
   a D2D subframe of the same connection and with any transmission direction, or
   a cellular TDD special subframe if the servicing base station is a TDD base station, and
the immediately following subframe is either:
   a D2D subframe of the same transmission direction, or
   a cellular downlink (DL) subframe if the base station is a TDD base station.

(Supplementary Note 6)

The signalling method as noted in Supplementary note 5, wherein the first D2D subframe type does not have a guard period at the beginning or at the end of the subframe.

(Supplementary Note 7)

The signalling method as noted in Supplementary note 6 wherein, in the case of normal cyclic prefix (CP) all 14 orthogonal frequency division multiplexing (OFDM) or single carrier frequency division multiple access (SC-FDMA) symbols are used for transmitting/receiving D2D channel(s) and/or D2D signal(s), or in the case of extended CP all 12 OFDM or SC-FDMA symbols are used for transmitting/receiving D2D channel(s) and/or D2D signal(s).

(Supplementary Note 8)

The signalling method as noted in any one of notes Supplementary note 4-7, wherein the plurality of different D2D subframe types includes a second D2D subframe type which is selected for use in transmitting D2D channel(s) and/or D2D signal(s) on a given subframe when:
the immediately preceding subframe is either:
   a D2D subframe of the same connection, or
   a cellular TDD special subframe if the servicing base station is a TDD base station, and
the immediately following subframe is either:
   a D2D subframe of the same connection with opposite transmission direction, or
   a D2D subframe of another connection, or
   a cellular UL subframe if the servicing base station is a TDD base station.

(Supplementary Note 9)

The signalling method as noted in Supplementary note 8, wherein the second D2D subframe type does not have a guard period at the beginning of the subframe but does have at least one guard period at the end of the subframe.

(Supplementary Note 10)

The signalling method as noted in Supplementary note 9 wherein, in the case of normal CP the first 13 OFDM or SC-FDMA symbols are used for transmitting/receiving D2D channel(s) and/or D2D signal(s), or in the case of extended CP the first 11 OFDM or SC-FDMA symbols are used for transmitting/receiving D2D channel(s) and/or D2D signal(s), and for both normal CP and extended CP the last OFDM or SC-FDMA symbol in the subframe is discontinuous transmission (DTX).

(Supplementary Note 11)

The signalling method as noted in any one of notes Supplementary note 4-10, wherein the plurality of different D2D subframe types includes a third D2D subframe type which is selected for use in transmitting D2D channel(s) and/or D2D signal(s) on a given subframe when:
the immediately preceding subframe is a cellular uplink (UL) subframe, and
the immediately following subframe is either:
   a D2D subframe of the same connection with the same transmission direction, or
   a cellular DL subframe if the servicing base station is a TDD base station.

(Supplementary Note 12)

The signalling method as noted in Supplementary note 11, wherein the third D2D subframe type does not have a guard period at the end of the subframe but does have at least one guard period at the start of the subframe.

(Supplementary Note 13)

The signalling method as noted in Supplementary note 12 wherein, in the case of normal CP the last 13 OFDM or SC-FDMA symbols are used for transmitting/receiving D2D channel(s) and/or D2D signal(s), or in the case of extended CP the last 11 OFDM or SC-FDMA symbols are used for transmitting/receiving D2D channel(s) and/or D2D signal(s), and for both normal CP and extended CP the first OFDM or SC-FDMA symbol is DTX.

(Supplementary Note 14)

The signalling method as noted in any one of notes Supplementary note 4-13, wherein the plurality of different D2D subframe types includes a fourth D2D subframe type which is selected for use in transmitting D2D channel(s) and/or D2D signal(s) on a given subframe when:
the immediately preceding subframe is a cellular UL subframe, and
the immediately following subframe is either:
   a D2D subframe of the same connection with opposite transmission direction, or
   a D2D subframe of another connection, or
   a cellular UL subframe.

(Supplementary Note 15)

The signalling method as noted in Supplementary note 14, wherein the fourth D2D subframe type has at least one guard period at the start of the subframe and also at least one guard period at the end of the subframe.

(Supplementary Note 16)

The signalling method as noted in Supplementary note 15 wherein, in the case of normal CP the 2nd to 13th OFDM or SC-FDMA symbols are used for transmitting/receiving D2D channel(s) and/or D2D signal(s), or in the case of extended CP the 2nd to 11th OFDM or SC-FDMA symbols are used for transmitting/receiving D2D channel(s) and/or D2D signal(s), and for both normal CP and extended CP the first and last OFDM or SC-FDMA symbol in a D2D subframe are DTX.

(Supplementary Note 17)

The signalling method as noted in Supplementary note 2 or 3, wherein the first D2D-UE and second D2D-UE, at least, are in cellular communication with different servicing base stations.

(Supplementary Note 18)

The signalling method as noted in Supplementary note 17, wherein the plurality of different D2D subframe types includes a first D2D subframe type which is selected for use in transmitting D2D channel(s) and/or D2D signal(s) on a given subframe when:
the immediately preceding subframe is a D2D subframe, and
the immediately following subframe is a D2D subframe of the same connection and transmission direction.

(Supplementary Note 19)

The signalling method as noted in Supplementary note 18, wherein the first D2D subframe type does not have a guard period at the beginning or at the end of the subframe.

(Supplementary Note 20)

The signalling method as noted in Supplementary note 19 wherein, in the case of normal CP all 14 OFDM or SC-FDMA symbols are used for transmitting/receiving D2D channel(s) and/or D2D signal(s), or in the case of extended CP all 12 OFDM or SC-FDMA symbols are used for transmitting/receiving D2D channel(s) and/or D2D signal(s).

(Supplementary Note 21)

The signalling method as noted in any one of notes Supplementary note 17-20, wherein the plurality of different D2D subframe types includes a second D2D subframe type which is selected for use in transmitting D2D channel(s) and/or D2D signal(s) on a given subframe when:
the immediately preceding subframe is a D2D subframe, and
the immediately following subframe is either:
   a D2D subframe of the same connection but with the opposite transmission direction, or
   a D2D subframe of another connection, or
   a cellular subframe, including a cellular UL subframe or a cellular DL subframe.

(Supplementary Note 22)

The signalling method as noted in Supplementary note 21, wherein the second D2D subframe type does not have a guard period at the start of the subframe but does have at least one guard period at the end.

(Supplementary Note 23)

The signalling method as noted in Supplementary note 22 wherein, in the case of normal CP the first 12 OFDM or SC-FDMA symbols are used for transmitting/receiving D2D channel(s) and/or D2D signal(s) and the last two symbols are DTX, or in the case of extended CP the first 11 OFDM or SC-FDMA symbols are used for transmitting/receiving D2D channel(s) and/or D2D signal(s) and the last symbol is DTX.

(Supplementary Note 24)

The signalling method as noted in any one of notes Supplementary note 17-23, wherein the plurality of different D2D subframe types includes a third D2D subframe type which is selected for use in transmitting D2D channel(s) and/or D2D signal(s) on a given subframe when:
the immediately preceding subframe is a cellular subframe, and
the immediately following subframe is a D2D subframe of the same connection with the same transmission direction.

(Supplementary Note 25)

The signalling method as noted in Supplementary note 24, wherein the third D2D subframe type does not have a guard period at the end of the subframe but it does have at least one guard period at the start of the subframe.

(Supplementary Note 26)

The signalling method as noted in Supplementary note 25 wherein, in the case of normal CP the last 13 OFDM or SC-FDMA symbols are used for transmitting/receiving D2D channel(s) and/or D2D signal(s), or in the case of extended CP the last 11 OFDM or SC-FDMA symbols are used for transmitting/receiving D2D channel(s) and/or D2D signal(s), and for both normal and extended CP the first symbol is DTX.

(Supplementary Note 27)

The signalling method as noted in any one of notes Supplementary note 17-26, wherein the plurality of different D2D subframe types includes a fourth D2D subframe type which is selected for use in transmitting D2D channel(s) and/or D2D signal(s) on a given subframe when:
the immediately preceding subframe is a cellular subframe, and
the immediately following subframe is either:
   a D2D subframe of the same connection with opposite transmission direction, or
   a D2D subframe of another connection, or
   a cellular subframe.

(Supplementary Note 28)

The signalling method as noted in Supplementary note 27, wherein the fourth D2D subframe type has at least one guard period at the start of the subframe and at least one guard period at the end of the subframe.

(Supplementary Note 29)

The signalling method as noted in Supplementary note 28 wherein, in the case of normal CP the first OFDM or SC-FDMA symbol is DTX, the 2nd to 12th OFDM or SC-FDMA symbols are used for transmitting/receiving D2D channel(s) and/or D2D signal(s) and the last two OFDM or SC-FDMA symbols are DTX, or in the case of extended CP the first OFDM or SC-FDMA symbol is DTX, the 2nd to 11th OFDM or SC-FDMA symbols are used for transmitting/receiving D2D channel(s) and/or D2D signal(s) and the last OFDM or SC-FDMA symbol is DTX.

(Supplementary Note 30)

The signalling method as noted in any one of notes Supplementary note 17-29, wherein the different base stations servicing the first D2D-UE and the second D2D-UE respectively are both TDD base stations, and the plurality of different D2D subframe types includes a fifth D2D subframe type which is selected for use in transmitting D2D channel(s) and/or D2D signal(s) on a given subframe when:
the immediately preceding subframe is a certain cellular special subframe, and
the immediately following subframe is either:
   a D2D subframe of the same connection but with opposite transmission direction, or
   a D2D subframe of another connection, or
   a cellular subframe.

(Supplementary Note 31)

The signalling method as noted in Supplementary note 30, wherein the fifth D2D subframe type has a guard period at the start of the subframe and at least one guard period at the end of the subframe.

(Supplementary Note 32)

The signalling method as noted in Supplementary note 31 wherein, in the case of normal CP the first 12 OFDM or SC-FDMA symbols are used for transmitting/receiving D2D channel(s) and/or D2D signal(s), the last two OFDM or SC-FDMA symbols are DTX and a retardation is applied to save one OFDM/SC-FDMA symbol, or in the case of extended CP the first OFDM/SC-FDMA symbol is DTX, the 2nd to 11th OFDM or SC-FDMA symbols are used for transmitting/receiving D2D channel(s) and/or D2D signal(s) and the last OFDM/SC-FDMA symbol is DTX.

(Supplementary Note 33)

The signalling method as noted in any one of Supplementary notes 4-32 wherein in transmitting one or more of the said D2D subframe types, a D2D-UE retards a subframe transmission for half of its network configured timing advance (TA) in comparison with a corresponding network configured cellular UL subframe.

Note that the present invention is not limited to the above-mentioned exemplary embodiments, and it is obvious that various modifications can be made by those of ordinary skill in the art based on the recitation of the claims.

This application is based upon and claims the benefit of priority from Australia Patent Application No. 2013904205, filed on Oct. 31, 2013, the disclosure of which is incorporated herein in its entirety by reference.

### REFERENCE SIGNS LIST

01,16 access node
03,04,06,13,14,18,19,104,105,204,205,304,305 user equipment (UE)
11,101,102,201,202,301,302 base station
130,134,230,238,330,338,400,401,420,430,450,510,530 D2D subframe

1. In a wireless communications system including a first device-to-device (D2D) communications capable user equipment (D2D-UE) and a second D2D-UE, a communications method implemented in the first D2D-UE, the communications method comprising:
transmitting, to the second D2D-UE, a D2D signal on a subframe.

2. The communications method as in claim 1, wherein the subframe comprises a guard period at either the beginning of the subframe or at the end of the subframe.

3. The communications method as in claim 1, wherein the subframe does not include a guard period.

4. The communications method as in claim 1,
wherein the subframe comprises 13 orthogonal frequency division multiplexing (OFDM) or single carrier frequency division multiple access (SC-FDMA) symbols in case of normal cyclic prefix (CP) for D2D communications, and
wherein the subframe comprises 11 orthogonal frequency division multiplexing (OFDM) or single carrier frequency division multiple access (SC-FDMA) symbols in case of extended cyclic prefix (CP) for D2D communications.

5. The communications method as in claim 1,
wherein the subframe comprises 14 orthogonal frequency division multiplexing (OFDM) or single carrier frequency division multiple access (SC-FDMA) symbols in case of normal cyclic prefix (CP) for D2D communications, and
wherein the subframe comprises 12 orthogonal frequency division multiplexing (OFDM) or single carrier frequency division multiple access (SC-FDMA) symbols in case of extended cyclic prefix (CP) for D2D communications.

6. The communications method as in claim 1,
wherein the wireless communications system further includes a base station, and
wherein the first D2D-UE and the second D2D-UE communicates with the base station.

7. The communications method as in claim 1,
wherein the wireless communications system further includes a first base station and a second base station, and
wherein the first D2D-UE communicates with the first base station and the second D2D-UE communicates with the second base station.

8. The communications method as in claim 1, wherein a subframe type is selected from a plurality of D2D subframe types.

9. The communications method as in claim 8, wherein the first D2D-UE does not inform the second D2D-UE of the subframe type.

10. The communications method as in claim 1, wherein the first orthogonal frequency division multiplexing (OFDM) or single carrier frequency division multiple access (SC-FDMA) symbol in the subframe is discontinuous transmission (DTX).

11. The communications method as in claim 1, wherein the last orthogonal frequency division multiplexing (OFDM) or single carrier frequency division multiple access (SC-FDMA) symbol in the subframe is discontinuous transmission (DTX).

12. A first device-to-device (D2D) communications capable user equipment (D2D-UE) used in a wireless communications system including the first D2D-UE and a second D2D-UE, the first D2D-UE comprising:
a transmitter to transmit, to the second D2D-UE, a D2D signal on a subframe.

13. A communications method implemented in a wireless communications system including a first device-to-device (D2D) communications capable user equipment (D2D-UE) and a second D2D-UE, the communications method comprising:
transmitting, from the first D2D-UE to the second D2D-UE, a D2D signal on a subframe.

14. A wireless communications system comprising:
a first device-to-device (D2D) communications capable user equipment (D2D-UE); and
a second D2D-UE,
wherein the first D2D-UE transmits, to the second D2D-UE, a D2D signal on a subframe.
